(19) United States
(12) Patent Application Publication
(10) Pub. No.: US 2024/0064557 A1
(43) Pub. Date: Feb. 22, 2024

(54) METHOD AND APPARATUS FOR GROUP QUALITY-OF-SERVICE CONTROL OF MULTIPLE QUALITY-OF-SERVICE FLOWS

(71) Applicant: HUAWEI TECHNOLOGIES CO., LTD., Shenzhen (CN)

(72) Inventors: Qing WEI, Munich (DE); Riccardo TRIVISONNO, Munich (DE); Mirko SCHRAMM, Berlin (DE)

(21) Appl. No.: 18/500,527

(22) Filed: Nov. 2, 2023

Related U.S. Application Data
(63) Continuation of application No. PCT/EP2021/062235, filed on May 7, 2021.

(51) Int. Cl. H04W 28/02; H04W 72/12; H04W 72/543

(52) U.S. Cl. CPC H04W 28/0268; H04W 72/12; H04W 72/543

(57) ABSTRACT

A control entity for controlling a communication service of a mobile communication network includes a first communication interface configured to obtain a group quality of service (QoS) treatment requirement for group QoS treatment of a traffic group including one or more communication services in the mobile communication network. The control entity also includes a processor configured to generate one or more QoS flow groups and a corresponding group QoS treatment policy for each QoS flow group based on the obtained group QoS treatment requirement and the traffic group. Each QoS flow group includes at least one of the communication services. The control entity further includes a second communication interface configured to provide QoS group information to one or more network entities in the mobile communication network. The QoS group information includes a QoS flow group identifier and the group QoS treatment policy for a corresponding QoS flow group.

### CROSS-REFERENCE TO RELATED APPLICATIONS

This application is a continuation of International Application No. PCT/EP2021/062235, filed on May 7, 2021, the disclosure of which is hereby incorporated by reference in its entirety.

### BACKGROUND

Industry scenarios bring extreme requirements for mobile communication networks, such as ultra-high communication service availability, time-sensitive communication with very low end-to-end (e2e) latency. For instance, in case of cooperative carrying of work pieces in the smart factories scenario, the communication service availability needs to reach 99.9999% to 99.999999% and e2e latency is required in the scale of milliseconds (e.g., 2.5 ms, 5 ms).

In the use case of cooperative carrying of work pieces, the different QoS flows are correlated. That means, in case of obstacles or radio quality degradation between the controlled automatic guided vehicle (AGV) and the controller, a single missing feedback, e.g. due to a delay in its reception exceeding the deadline at the controller, forces to fail the complete control or communication cycle, respectively. In such a case, the resource reserved to fulfill the QoS requirements of other feedbacks is wasted.

### SUMMARY

It is an objective of this disclosure to improve a performance of mobile communication networks with respect to resource utilization efficiency and control cycle losses, particularly for the above described scenarios of cooperative carrying of work pieces and other cooperative processing scenarios.

One or more of these objectives is achieved by the features of the independent claims. Further implementation forms are apparent from the dependent claims, the description and the figures.

A basic idea of this disclosure is to enable group QoS control of multiple correlated QoS flows to reduce the occurrence of control cycle loss and maximize the resource utilization efficiency. The disclosure presents methods and apparatuses for group QoS control of correlated QoS flows.

A concept of this disclosure can be summarized as follows. A QoS control entity provides a “Group QoS profile” for correlated QoS flows to one or more QoS assurance entities for joint QoS treatment. The QoS control entity is a network function/entity for QoS rule and policy control in a mobile network (e.g., embedded within the PCF). QoS flows in the same group are jointly handled at the QoS assurance entities according to the Group QoS treatment policy in the “Group QoS profile”. The QoS assurance entity is a network function/entity for QoS enforcement in the mobile network (e.g., RAN, SMF, etc.). The QoS control entity obtains the Group QoS requirement(s) (e.g., joint QoS fulfillment, synchronized QoS fulfillment, fair QoS fulfillment) and group membership information from the application layer and derives the Group QoS treatment policy per QoS assurance entity. The Group QoS treatment policy can be group QoS fulfillment policy or group resource management policy for joint QoS fulfillment, aligned QoS fulfillment, fair QoS fulfillment of the QoS flows in that group from the application layer.

The “Group QoS profile” is implemented based on the flow-based QoS model described below with respect to FIG. 2. This means, application/service layer packets are still mapped into QoS flows using a packet filter, and each QoS flow is given a flow ID and bound to a QoS profile (e.g., by the PCF) which indicates the QoS attributes to be fulfilled for this QoS flow. The difference is that each QoS flow is given also QoS Group information in addition to the QoS profile.

Such QoS Group information includes: QoS Flow Group ID (QFGI); group QoS treatment policy that indicates the policy how the QoS profile of each individual QoS flow in the group should be treated jointly (e.g., group QoS fulfillment policy/group resource management policy for joint/synchronized/fair QoS fulfillment, etc.); parameters specifying the usage of Group QoS treatment policy, including: pattern of group treatment; an execution in the flow life time, or periodical (e.g., for each control cycle/communication cycle etc.); group treatment validate condition (e.g., minimum group size).

Such QoS Group information is used by the QoS assurance entity for group QoS treatment.

This concept provides the following technical advantages: 1) Service improvement for scenarios with collaborative UEs due to a reduction of the occurrence of control cycle loss (by intra/inter-group resource coordination and smart resource scheduling e.g., via selective service assurance); 2) Increased communication reliability for given radio conditions (by enabling smart resource scheduling intra-group/inter-groups). Leveraging on group QoS treatment, the reliability of the QoS fulfillment for each individual QoS Flow of the group AND for the QoS groups can be increased; 3) More efficient resource utilization (by joint QoS treatment of the QoS flows in a group), e.g. in case one of the QoS cannot be fulfilled in the group, the resource for the group can be saved for communications in other groups.

Resource allocation can be prioritized to a more appropriate QoS flow (e.g., QoS flow taking less radio resources, QoS flow more critical from the application point of view) in the group considering the group QoS requirement(s).

Meanwhile, the disclosed solution is robust and applicable for a broad scope of scenarios. It is applicable to a QoS flow group with both the same QoS requirement(s) and different QoS requirements. It can also support a dynamic communication group where the collaborative UEs may join and leave the communication group during the life-time of the group.

The disclosed solution is compatible with the current QoS control mechanism based on current QoS profile and backwards compatible. The QoS flows do not belong to any QoS flow group and can still be treated as it is, by using the current QoS profile.

Additionally, a UE can have simultaneously both the QoS flows treated with current QoS profile and QoS flows treated with group QoS profile.

In case the QoS assurance network entity (e.g., certain RAN/SMF) does not support the group QoS profile (i.e., additional group QoS information to the current QoS profile), the additional information can be ignored and flows can be treated using the current QoS profile. There will be no conflicts to the current per flow-based QoS model.

The disclosure as described in the following presents a group (multiple flows) QoS model and the corresponding group QoS control methods, which include the following: 1) A method to implement the “Group QoS profile” based on the current QoS profile, i.e., Group QoS information, which includes one or more of: (i) an identifier of a QoS flow group; (ii) a group QoS treatment policy of the QoS flows in the group (e.g., group QoS fulfillment policy, group resource management policy for joint fulfillment, synchronized fulfillment, fair fulfillment; (iii) parameters for group treatment (e.g., pattern, validation condition). 2) A method and apparatus (i.e., QoS control entity) to determine the QoS flow group and corresponding group QoS treatment policy, which includes: (i) obtaining the group QoS requirement(s) and group membership information from the application; (ii) determining the QoS flow group and corresponding group QoS treatment policy (i.e., group QoS information) per QoS assurance entity based on the obtained group QoS requirement(s) and group membership information. 3) A method to provide the Group QoS information from the QoS control entity to one or more QoS assurance entities; and 4) Methods for group QoS treatment using group QoS information at the QoS assurance entity.

According to a first aspect, the disclosure relates to a control entity for controlling a communication service of a mobile communication network, the control entity comprising: a first communication interface configured to obtain a group Quality of Service, QoS, treatment requirement for group QoS treatment of a traffic group comprising one or more communication services, e.g. communication services from one or more User Equipments, UEs, in the mobile communication network; a processor configured to generate one or more QoS flow groups and a corresponding group QoS treatment policy for each QoS flow group based on the obtained group QoS treatment requirement and the traffic group, wherein each QoS flow group comprises at least one of the one or more communication services; and a second communication interface configured to provide QoS group information to one or more network entities, e.g. QoS assurance network entities, in the mobile communication network, the QoS group information comprising a QoS flow group identifier, QFGI, and the group QoS treatment policy for the respective QoS flow group.

Such a control entity improves the performance of mobile communication networks with respect to resource utilization efficiency and control cycle losses, for example, for the scenarios of cooperative carrying of work pieces and other cooperative processing scenarios as shown in this disclosure. Using such a control entity enables group QoS control of multiple correlated QoS flows reducing the occurrence of control cycle loss and maximizing the resource utilization efficiency. The control entity supports group QoS control of correlated QoS flows from one or multiple UEs.

The group QoS treatment requirement for group QoS treatment of a traffic group as defined above is not really a requirement but rather a kind of support information indicating the dependency between the communication services and how to make use of it (compared to the current situation where every service is treated independently). Group treatment of a traffic group as defined above means the joint handling of QoS related requirement for each member of the traffic group, i.e. handling under a common mechanism.

A traffic group as described above may include one or more communication services of one or more UEs. A communication service may be, for example, a time-sensitive communication with very low end-to-end latency and very high reliability, for example in the case of cooperative carrying of work pieces by mobile robots (i.e. UEs) in a factory scenario. For example, one mobile robot takes the role of the controller while other mobile robots provide feedback to the controller via a D2D link. Each D2D link may be treated under the same traffic group to guarantee ultra-high communication service availability, e.g. between 99.9999% and 99.999999%.

The one or more communication services may, for example, be communication services of one or more User Equipments in the mobile communication network.

In an exemplary implementation of the control entity, the processor is further configured to assign a corresponding QoS flow group identifier, QFGI, to the one or more QoS flow groups.

In case a UE can move between different assurance entities (i.e., RANs), the QFGI assigned to different QoS flow groups of the same traffic group should use the same value. In other scenarios, e.g., a UE is always controlled by the same assurance entity, the QFGI assigned to different QoS flow groups of the same traffic group can be the same or different.

Each QoS flow group is identified by a unique QFGI. QoS flow groups of different traffic groups are identified by different QFGIs.

In an exemplary implementation of the control entity, the group QoS treatment requirement is obtained directly from an application layer or from the application layer via a network entity, for example, an Application Function, AF, and/or a Network Exposure Function, NEF, and/or a Unified Data Repository, UDR.

The application layer can be an application server running at a data center and/or an application client running at the UE.

In Uu case (i.e., UE to network communication), the group QoS treatment requirement(s) may be obtained from the application layer via AF and NEF, or AF via NEF via UDR. In PC5 case (i.e., UE to UE communication), the group QoS treatment requirement(s) may be obtained directly from the application layer.

In an exemplary implementation of the control entity, the group QoS treatment requirement is obtained together with a traffic group identifier of the traffic group directly from the application layer or from the application layer via the network entity, e.g. the AF and/or the NEF, wherein the traffic group identifier is configured to identify the traffic group.

The traffic group identifier (ID) is a unique identifier of the corresponding traffic group. Different traffic groups are identified by different traffic group IDs. There may be a mapping between external traffic group IDs as known by the application layer and traffic group IDs as known by the PCF. NEF may convert between external traffic group IDs and traffic group IDs, e.g. as described below with respect to FIGS. 7, 8, 9.

In an exemplary implementation of the control entity, the traffic group identifier of the traffic group is obtained directly from the application layer or from the application layer via the network entity, e.g. the AF and/or the NEF, and the group QoS treatment requirement is obtained from a database, e.g. a Unified Data Repository, UDR, entity, per application, wherein the traffic group identifier is configured to identify the traffic group.

As described above, the traffic group identifier (ID) is a unique identifier of the corresponding traffic group. Different traffic groups are identified by different traffic group IDs. There may be a mapping between external traffic group IDs as known by the application layer and traffic group IDs as known by the PCF. NEF may convert between external traffic group IDs and traffic group IDs (see FIGS. 6, 7, 8 of IDF).

In an exemplary implementation of the control entity, the group QoS treatment policy comprises at least one of: a percentage of communication services of the one or more communication services in the QoS flow group of which the QoS needs to be fulfilled, or a percentage of communication services of the one or more communication services in the QoS flow group of which the QoS does not need to be fulfilled, a percentage of communication services in the QoS flow group to be treated as a whole for group resource management, a parameter controlling a fair chance of QoS fulfillment and/or group resource management for each communication service within the QoS flow group, an indication of an allowed communication latency threshold with respect to a number of control cycles, a parameter for aligning arrival time. The arrival time means the arrival time at the receiver, i.e. at the receiver side of the communication service. In UE to UE communication, the receiver is the UE; while in UE to network communication, the receiver is the data network, i.e. the other end point of the QoS flow.

If the percentage of communication services in the QoS flow group of which the QoS needs to be fulfilled is 100 percent, then QoS of all of the communication services in the QoS flow group shall be satisfied.

Communication services in the QoS flow group to be treated as a whole for group resource management means the resource needs to be allocated as a whole. If the percentage of these communication services is 100 percent, the resource should be allocated only if QoS of all the communication services in the QoS flow group can be fulfilled. This covers the case of joint admission control of the complete group.

A chance or a fair chance of QoS fulfillment may be a kind of sharing mechanism for controlling QoS fulfillment, e.g. a sharing mechanism for sharing resources between the communication services in order to fulfill QoS. A parameter controlling the chance or fair chance may be some adaptation parameter for the sharing mechanism, e.g. according to a weighted QoS fulfillment for the corresponding communication services.

An aligned arrival time as defined above means the variation of the arrival time should be limited to a certain range (e.g., variation+−5%); the parameter is the variation.

Another possibility of implementation is that there are already multiple QoS parameters (e.g., allowed latency) defined for each traffic flow. Application requires RAN to implement the same value of the QoS parameters when possible.

In an exemplary implementation of the control entity, the group QoS treatment requirement comprises at least one of: a percentage of communication services of the one or more communication services in the traffic group of which the QoS needs to be fulfilled, a percentage of communication services of the one or more communication services in the traffic group of which the QoS does not need to be fulfilled, a percentage of communication services in the traffic group to be treated as a whole for group resource management, a parameter controlling a chance of QoS fulfillment and/or group resource management for each communication service within the traffic group, an indication of an allowed communication latency threshold with respect to a number of control cycles, and a parameter for aligning arrival time. The arrival time means the arrival time at the receiver, i.e. at the receiver side of the communication service. In UE to UE communication, the receiver is the UE; while in UE to network communication, the receiver is the data network, i.e. the other end point of the QoS flow.

If the percentage of communication services in the traffic group of which the QoS needs to be fulfilled is 100 percent, then QoS of all of the communication services in the traffic group shall be satisfied.

Communication services in the traffic group to be treated as a whole for group resource management means the resource needs to be allocated as a whole. If the percentage of these communication services is 100 percent, the resource should be allocated only if QoS of all the communication services in the traffic group can be fulfilled. This covers the case of joint admission control of the complete group.

In an exemplary implementation of the control entity, a policy for the group resource management, also referred to as “group resource management policy”, comprises at least one of: a combined admission control, e.g. during QoS flow establishment or handover, and a combined smart resource scheduling at a Radio Access Network, RAN.

In an exemplary implementation of the control entity, the group QoS treatment policy further comprises information dedicated for the group QoS treatment, wherein the information dedicated for the group QoS treatment comprises at least one of: a validating condition of the group QoS treatment, e.g. a minimum group size, a temporal validity condition, a spatial validity condition, and group QoS treatment pattern, e.g. an execution of group QoS treatment periodically or in a flow life-time.

Temporal validity condition may be a day time, e.g. 14:00-15:00, day, workday. Spatial validity condition may be a geographical area, e.g. indicated by cell ID or tracking area ID.

In an exemplary implementation of the control entity, the group QoS treatment requirement further comprises information dedicated for the group QoS treatment, wherein the information dedicated for the group QoS treatment comprises at least one of: validating conditions of the group QoS treatment, e.g. a minimum group size, a temporal validity condition, a spatial validity condition, and a group QoS treatment pattern, e.g. an execution of group QoS treatment periodically or in a flow life time.

In an exemplary implementation of the control entity, the second communication interface is configured to provide the QoS group information together with a QoS profile per QoS flow to the one or more network entities, e.g. the one or more QoS assurance network entities, based on a Session Management, SM and/or a policy association procedure.

PCF provides the QoS group information to SMF using a policy association procedure. SMF provides the QoS group information to RAN using a session management procedure.

In an exemplary implementation of the control entity, the second communication interface is configured to provide the QoS group information together with a QoS profile per QoS flow to the one or more network entities, e.g. the one or more QoS assurance network entities, based on a Session Management, SM, procedure via an Access and Mobility management Function, AMF, entity.

In an exemplary implementation of the control entity, the control entity is implemented in a network function entity of the mobile communication network, e.g. a 5G mobile communication network, or a Policy Control Function entity, e.g. a 5G Policy Control Function entity, and/or a Network Exposure Function entity, e.g. a 5G Network Exposure Function entity of the mobile communication network, e.g. a 5G mobile communication network.

In an exemplary implementation of the control entity, the control entity is implemented in a user device.

In an exemplary implementation of the control entity, the control entity is implemented in a user device, and the second communication interface is configured to provide the QoS group information together with a QoS profile per QoS flow to a Radio Access Network entity of the mobile communication network via Radio Resource Control signaling.

In an exemplary implementation of the control entity, the group QoS requirement(s) and group membership information are configured by the OAM at the PCF, the following interactions can be skipped.

In an exemplary implementation of the control entity, the group QoS requirement(s) and group membership information are configured by the OAM at the NEF or UDR, the following interactions between AF and NEF, UDR can be skipped.

According to a second aspect, the disclosure relates to a network entity for assuring a Quality of Service, QoS, of a traffic group comprising one or more communication services of one or more User Equipments, UEs, in a mobile communication network, the network entity comprising: a communication interface configured to receive QoS group information, the QoS group information comprising a QoS flow group identifier, QFGI, and a group QoS treatment policy for a respective QoS flow group comprising one or more communication services of the mobile communication network; and a processor configured to process a communication service of the mobile communication network that is assigned to the QoS flow group based on the group QoS treatment policy. In one implementation, the communication service is processed further based on a QoS profile of a QoS flow assigned to the communication service.

Such a network entity improves performance of mobile communication networks with respect to resource utilization efficiency and control cycles losses, for example, for the scenarios of cooperative carry of work pieces and other cooperative processing scenarios as shown in this disclosure. Using such network entity enables group QoS control of multiple correlated QoS flows reducing the occurrence of control cycles loss and maximizing the resource utilization efficiency. The network entity supports group QoS control of correlated QoS flows.

In an exemplary implementation of the network entity, the QoS Flow group identifier, QFGI, is assigned to the respective QoS flow group.

In an exemplary implementation of the network entity, the group QoS treatment policy for the respective QoS flow group comprises at least one of: a percentage of communication services of the one or more communication services in the respective QoS flow group and/or traffic group of which the QoS needs to be fulfilled, a percentage of communication services of the one or more communication services in the respective QoS flow group and/or traffic group of which the QoS does not need to be fulfilled, a percentage of communication services in the QoS flow group and/or traffic group to be treated as a whole for group resource management, a parameter controlling a fair chance of QoS fulfillment and/or group resource management for each communication service within the respective QoS flow group and/or traffic group, an indication of an allowed communication latency threshold with respect to a number of control cycles, and a parameter for aligning an arrival time. The arrival time means the arrival time at the receiver, i.e. at the receiver side of the communication service. In UE to UE communication, the receiver is the UE; while in UE to network communication, the receiver is the data network, i.e. the other end point of the QoS flow.

In an exemplary implementation of the network entity, a policy for the group resource management, comprises at least one of: a combined admission control, e.g. during QoS flow establishment or handover, and a combined smart resource scheduling at a Radio Access Network, RAN.

In an exemplary implementation of the network entity, the group QoS treatment policy for a respective QoS flow group further comprises information dedicated for the group QoS treatment, wherein the information dedicated for the group QoS treatment comprise at least one of: a validating condition of the group QoS treatment, e.g. a minimum group size, a temporal validity condition, a spatial validity condition, and a group QoS treatment pattern, e.g. an execution of group QoS treatment periodically or in a flow life-time.

In an exemplary implementation of the network entity, the processor is further configured to perform at least one of assigning resources, performing smart scheduling, performing an admission control, and performing QoS assurance of the mobile communication network to the communication service based on the group QoS treatment policy and a QoS profile of a QoS flow assigned to the communication service.

In an exemplary implementation of the network entity, the network entity further comprises a Radio Access Network entity and/or a Core Network entity, e.g. a Session Management Function entity of the mobile communication network, e.g. of a 5G mobile communication network.

In an exemplary implementation of the network entity, the QoS group information is part of a QoS profile assigned to the communication service. Group QoS profile may be implemented as an extended QoS profile: In case the multiple QoS flows (with different packet filter and flow ID) in a QoS flow group have the same QoS profile, they can be bound to one QoS profile by the PCF. In this case, the QoS profile can be extended with additional QoS Group information to enable group QoS treatment.

In an exemplary implementation of the network entity, the processor is configured to process the communication service of the mobile communication network based on the QoS profile assigned to the communication service if the QoS group information is unavailable or unknown to the processor.

According to a third aspect, the disclosure relates to a system for group QoS control of multiple QoS flows, the system comprising: a control entity according to the first aspect for controlling one or more communication services of a mobile communication network; and one or more network entities according to the second aspect for assuring QoS of the one or more communication services of the mobile communication network.

According to a fourth aspect, the disclosure relates to a method for controlling a communication service of a mobile communication network, the method comprising: obtaining group Quality of Service, QoS, treatment requirement(s) 621 for group QoS treatment of a traffic group comprising one or more communication services of one or more UEs in the mobile communication network 600; generating one or more QoS flow groups and a corresponding group QoS treatment policy for each QoS flow group based on the obtained group QoS treatment requirement(s) 621 and the traffic group, wherein each QoS flow group comprises at least one of the one or more communication services; and providing QoS group information to one or more network entities, for example, QoS assurance network entities in the mobile communication network, the QoS group information comprising a QoS flow group identifier, QFGI, and the group QoS treatment policy for the respective QoS flow group.

According to a fifth aspect, the disclosure relates to a method for assuring a Quality of Service, QoS, of a traffic group comprising one or more communication services in a mobile communication network, the method comprising: receiving QoS group information, the QoS group information comprising a QoS flow group identifier, QFGI, and a group QoS treatment policy for a respective QoS flow group comprising one or more communication services of the mobile communication network; and processing a communication service of the mobile communication network that is assigned to the QoS flow group based on the group QoS treatment policy. In one implementation, the communication service is processed further based on a QoS profile of a QoS flow assigned to the communication service.

According to a sixth aspect, the disclosure relates to a computer program product including computer executable code or computer executable instructions that, when executed, causes at least one computer to execute the method according to the fourth or fifth aspect.

The computer program product may run on any of the components of a communication system described below with respect to FIG. 19. For example, the computer program product may run on a QoS control entity user device 1920 as shown in FIG. 19. Such a QoS control entity may comprises a processing circuitry 1923 for instance, a processor 1923, for processing and generating data, e.g. the program code described above, a transceiver 1925, including, for instance, an transmitter, a receiver and an antenna, for exchanging data with the other components of the communication system 1900, and a non-transitory memory 1927 for storing data, e.g. the program code described above. The computer program product may also run on a QoS assurance entity implemented in a RAN 1910, 1940 as shown in FIG. 19.

According to a seventh aspect, the disclosure relates to a computer-readable medium storing instructions that, when executed by a computer, cause the computer to execute the method according to the fourth or fifth aspect. Such a computer readable medium may be a non-transient readable storage medium. The computer may be, for example, a network device, e.g. the network device according to the second aspect comprising a processor, a transceiver and a memory as shown in FIG. 19. The computer-readable medium may be stored in the memory of the network device. The instructions stored on the computer-readable medium may be executed by the processor of the network device.

### BRIEF DESCRIPTION OF THE DRAWINGS

Example embodiments of this disclosure will be described with respect to the following figures, in which:

FIG. 1 shows a schematic diagram illustrating an industry scenario 100 where mobile robots cooperatively carry a heavy work piece;

FIG. 2 shows a schematic diagram of a mobile communication system 200 illustrating the principle for mapping application layer packets to QoS flows in mobile network;

FIG. 3 shows a schematic diagram illustrating a scenario 300 of a failed control cycle due to a single late feedback;

FIG. 4 shows a schematic diagram illustrating a mobile communication system 400 with controller at the edge for multiple sensors and/or cameras;

FIG. 5 shows a schematic diagram illustrating a mobile network architecture 500;

FIG. 6 shows a schematic diagram illustrating a mobile communication system 600 with QoS control entity and QoS assurance entities according to the disclosure;

FIG. 7 shows a message sequence chart 700 illustrating an exemplary procedure of “setting up an AF session with required QoS” according to a first option (option 1) according to the disclosure;

FIG. 8 shows a message sequence chart 800 illustrating an exemplary procedure of “setting up an AF session with required QoS” according to a second option (option 2) according to the disclosure;

FIG. 9 shows a message sequence chart 900 illustrating an exemplary procedure of “set a policy for a future AF session” according to the second option (option 2) according to the disclosure;

FIG. 10 shows a message sequence chart 1000 illustrating an exemplary SMF policy association establishment/modification procedure according to the disclosure;

FIG. 11 shows a message sequence chart 1100 illustrating an exemplary PDU session establishment procedure according to the disclosure;

FIG. 12 shows a schematic diagram illustrating a mobile communication system 1200 in PC5 QoS case where QoS control entity is located at the UE, with determining and provisioning of QoS group information according to the disclosure;

FIG. 13 shows a schematic diagram illustrating an exemplary D2D communication scenario 1300 with one cooperative group according to the disclosure;

FIG. 14 shows a schematic diagram illustrating an exemplary scenario 1400 of group QoS treatment using joint fulfillment according to the disclosure, without group QoS treatment and with group QoS treatment, respectively;

FIG. 15 shows a schematic diagram illustrating an exemplary scenario 1500 of group QoS treatment using aligned fulfillment according to the disclosure, without group QoS treatment and with group QoS treatment, respectively;

FIG. 16 shows a schematic diagram illustrating an exemplary scenario 1600 of group QoS treatment using fair fulfillment according to the disclosure, without group QoS treatment and with group QoS treatment, respectively;

FIG. 17 shows a schematic diagram illustrating an exemplary D2D communication scenario 1700 with two cooperative groups according to the disclosure;

FIG. 18 shows a schematic diagram illustrating an exemplary scenario 1800 of group QoS treatment using joint fulfillment according to the disclosure, without group QoS treatment and with group QoS treatment, respectively;

FIG. 19 shows a schematic diagram illustrating a mobile communication system 1900 supporting group QoS control according to the disclosure;

FIG. 20 shows a schematic diagram illustrating a method 2000 for controlling communication service of a mobile communication network according to the disclosure; and

FIG. 21 shows a schematic diagram illustrating a method 2100 for assuring Quality of Service according to the disclosure.

### DETAILED DESCRIPTION OF EMBODIMENTS

In order to describe the embodiments in detail, the following terms, abbreviations and notations will be used:
NF Network Function
QoS Quality of service
PCF Policy Control Function
NEF Network Exposure Function
UDM Unified Data Management
UDR User Data Repository
AF Application Function
AGV Automatic Guided Vehicles
PDB Packet delay budget
ARP Allocation and Retention Priority
PDCP Packet Data Convergence Protocol
AS Access Stratum
RRC Radio Resource Control
UE user equipment
AMF access and mobility management function (entity)
NF network function
CN core network
RAN radio access network
ID identifier
QFGI QoS Flow Group ID

In the following detailed description, reference is made to the accompanying drawings, which form a part thereof, and in which is shown by way of illustration specific aspects in which the disclosure may be practiced. It is understood that other aspects may be utilized and structural or logical changes may be made without departing from the scope of the present disclosure. The following detailed description, therefore, is not to be taken in a limiting sense, and the scope of the present disclosure is defined by the appended claims.

It is understood that comments made in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless noted otherwise.

The methods, devices and systems described herein may be implemented in mobile communication networks, for example, LTE, 5G, or 5G beyond. The described devices may include integrated circuits and/or passives and may be manufactured according to various technologies. For example, the circuits may be designed as logic integrated circuits, analog integrated circuits, mixed signal integrated circuits, optical circuits, memory circuits and/or integrated passives.

In the present disclosure, a User Equipment (UE) is described. The UE may be referred to as user device in some embodiments, and a UE may be, for example, a vehicle, e.g. an automatic guided vehicle, a mobile robot, a device to device (D2D) equipment, or any smart device. The UE may be for example, a mobile phone, an intelligent terminal, a tablet computer (tablet), a notebook computer (laptop), a video game console, a multimedia player, etc.

The devices and entities described herein may be configured to transmit and/or receive radio signals. Radio signals may be or may include radio frequency signals radiated by a radio transmitting device (or radio transmitter or sender). However, devices and entities described herein are not limited to transmit and/or receive radio signals, also other signals designed for transmission in deterministic communication networks may be transmitted and/or received.

The devices, entities and systems described herein may include processors or processing devices, memories and transceivers, i.e. transmitters and/or receivers. The term “processor” or “processing device” describes any device that can be utilized for processing specific tasks (or blocks or steps). A processor or processing device can be a single processor or a multi-core processor or can include a set of processors or can include means for processing. A processor or processing device can process software or firmware or applications etc.

The devices, entities and systems described herein may include communication interfaces, e.g. transceivers or transceiver devices. A transceiver is a device that is able to both transmit and receive information or send and/or receive a signaling message or obtain information. It is a combination of a transmitter and a receiver, hence the name transceiver. Transmission may be accomplished via radio waves or via electrical line transmission. By combining a receiver and transmitter in one consolidated device, a transceiver allows for greater flexibility than what either of these could provide individually.

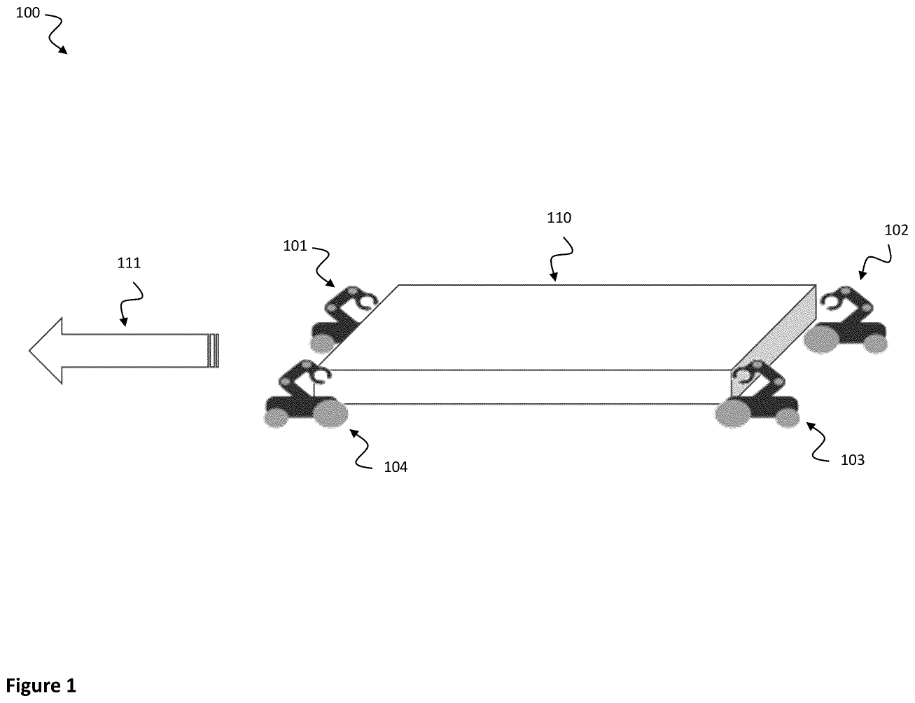

FIG. 1 shows a schematic diagram illustrating an industry scenario 100 where mobile robots cooperatively carry a heavy work piece.

In case of cooperative carrying (and movement) 111 of work pieces 110 as illustrated in FIG. 1, one mobile robot/AGV, e.g. vehicle 101, takes the role of the controller of other collaborating controlled mobile robots/AGVs, e.g. vehicles 102, 103, 104. In each control cycle/communication cycle, the controller 101 gets feedback from all controlled robots/AGVs 102, 103, 104 via device-to-device (D2D) link, processes the feedback, and sends the control commands to all the controlled robots/AGVs 102, 103, 104 again via D2D link. Each D2D link needs to guarantee the extreme service requirements mentioned below, which requires dedicated network resource reservation. Then, the trade-off is always between the required network resource and QoS fulfillment from application point of view.

Such industry scenarios 100 as shown in FIG. 1 bring extreme requirements for mobile communication, such as ultra-high communication service availability, time sensitive communication with very low e2e latency. For instance, in case of cooperative carry of work pieces in smart factories scenario as illustrated in FIG. 1, the communication service availability needs to reach 99.9999% to 99.999999% and e2e latency is in the scale of ms (e.g., 2.5 ms, 5 ms).

Communication service availability refers to percentage value of the amount of time the end-to-end communication service is delivered according to an agreed QoS, divided by the amount of time the system is expected to deliver the end-to-end service according to the specification in a specific area according to technical specification TS22.104 v17.4.0.

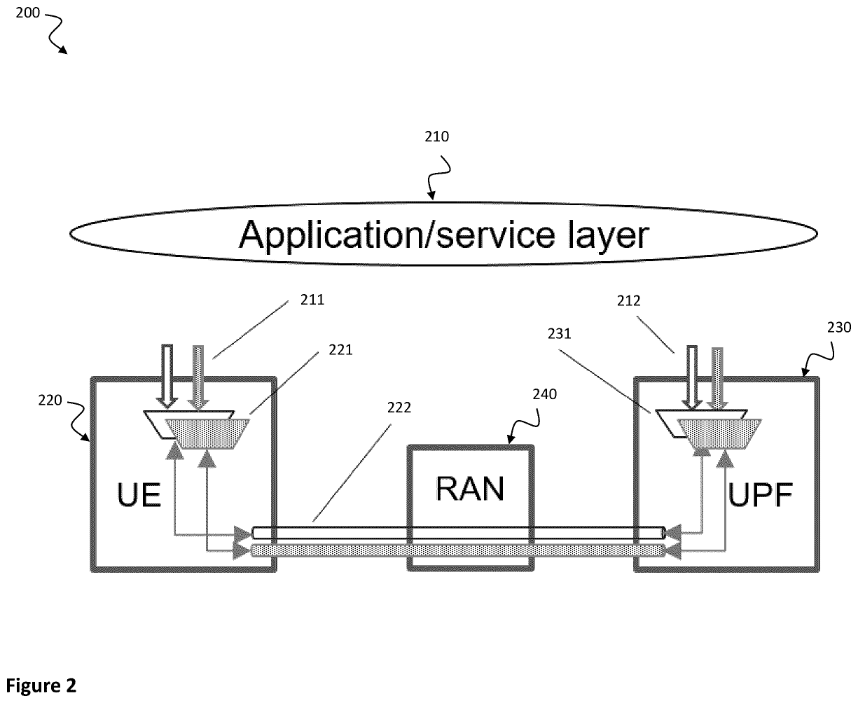

FIG. 2 shows a schematic diagram of a mobile communication system 200 illustrating the principle for mapping application layer packets 211, 212 to QoS flows 222 in mobile network for UE to network communication case.

In the mobile communication system 200, application layer packets 211, 212 from application/service layer 210 are transmitted between user equipment (UE) 220 and user plane function (UPF) 230 via Radio Access Network (RAN) 240.

In a mobile communication system 200 according to 5G mobile network technology, QoS (Quality of service) is managed and controlled per QoS flow 222. Application/service layer packets 211, 212 are mapped into QoS flows 222 using a packet filter 221, 231 applying QoS rules. Each QoS flow 222 is bound to a QoS Profile (which is derived from the application layer service requirement(s)). The network entities (e.g., RAN 240, SMF) treat each QoS flow 222 separately according to the correspondent QoS Profile.

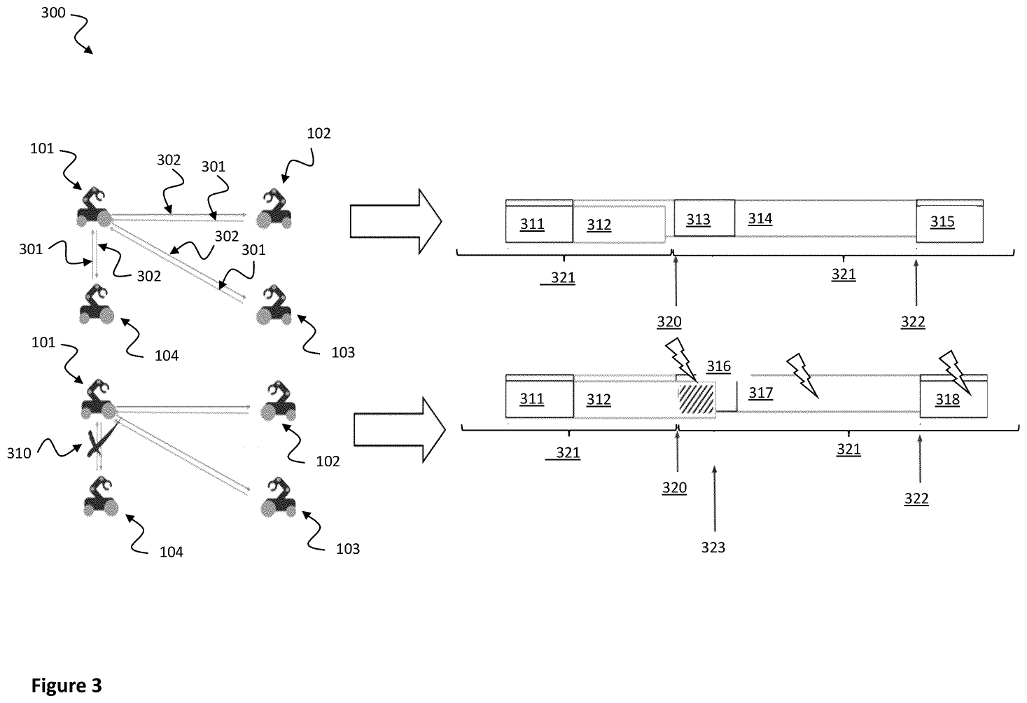

FIG. 3 shows a schematic diagram illustrating a scenario 300 of a failed control cycle due to a single late feedback.

A properly working control cycle is shown in the upper part of FIG. 3, while a failed control cycle due to a single late feedback is shown in the lower part of FIG. 3.

In the upper part of FIG. 3, the controller, e.g. vehicle 101, receives a status report and control feedback 301 from all controlled vehicles, e.g. AGVs 102, 103, 104. Based on these feedbacks 301, the controller 101 transmits control commands 302 to the controlled vehicles 102, 103, 104. The corresponding timing is shown in the right part of FIG. 3. The first frame 311 is used to indicate “controlled robot feedback ready”; the second frame 312 (that corresponds to the status report and control feedback 301 described above) is used to transmit “feedback” from the controlled AGV to the controller AGV. The “feedback” 312 is received within deadline at controller 320. The third frame 313 is used to indicate “controller commands ready”; the fourth frame 314 (that corresponds to the control commands 302 described above) is used to transmit “1: M communication for control commands” from the controller AGV to controlled AGVs. The control commands is received within deadline at controlled robots 322. The whole control cycle is completed properly. Then, the fifth frame 315 indicates procedure at controlled robots based on the received control command.

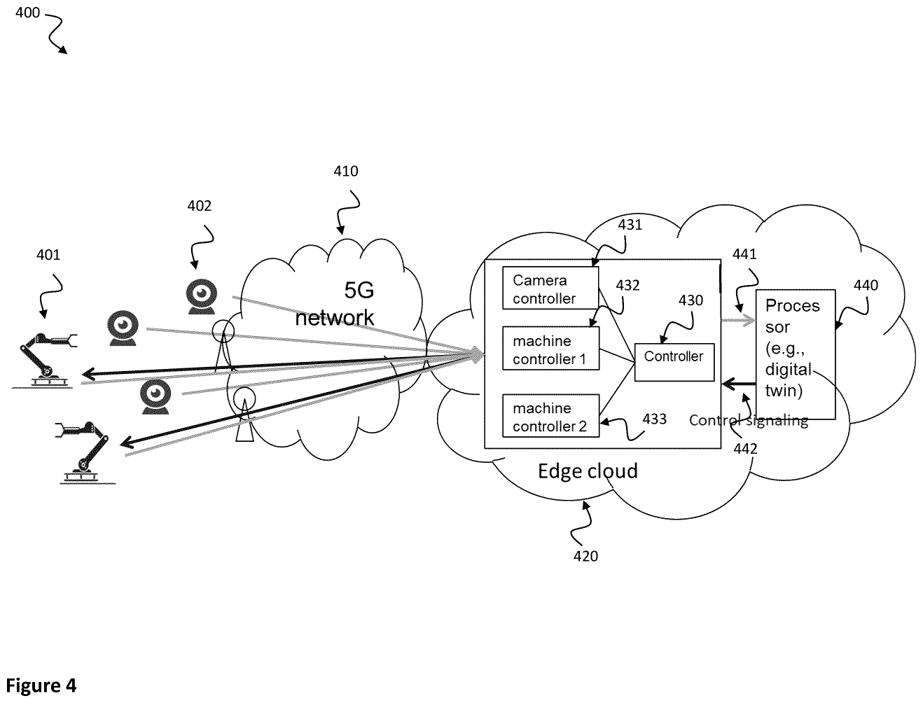

In the lower part of FIG. 3, the controller 101 receives a status report and control feedback 301 from all controlled vehicles 102, 103, 104. However, between controller 101 and controlled vehicle 104 an obstacle is placed which affects the reception of feedback 310 from this controlled vehicle 104. The corresponding timing is shown in the right part of FIG. 3. The first frame 311 is used to indicate “controlled robot feedback ready”; the second frame 312 (that corresponds to the status report and control feedback 301 described above) which is used to transmit “feedback” cannot be finished within deadline at controller 320 as a late feedback 323 is received after deadline at controller 320. Thus, the controller AGV could not process the control commands properly in the third frame 316, and the fourth frame 317 (that corresponds to the control commands 302 described above) is a lost slot that cannot be used. When the control cycle 321 is finished, FIG. 4 shows a schematic diagram illustrating a mobile communication system 400 with a controller at the edge for multiple sensors (e.g. installed on the cooperative mobile robots) and/or cameras.

In this example, sensors that may be installed on the mobile robots 401 and/or cameras 402 are controlled via 5G network 410 by a controller 430 and processor 440 implemented in an edge cloud 420. The controller comprises a camera controller 431 for controlling the cameras 402 and two machine controllers 432, 433 for controlling the sensors installed on the mobile robots 402. Sensor readings (data or information obtained by a sensor) 441 from the cooperative mobile robots and cameras are transmitted from controller 430 to processor 440 and control signaling 442 from processor 440 to controller 430.

In this example, the controller 430 (and processor 440) of multiple cooperative mobile robots 401, 402 may be placed at an edge cloud 420 (e.g., controller 430 and processor 440) as shown in FIG. 4. For example, the processor 440 may digitally duplicate the real world mobile robots and related environment using the received sensor data and use that for simulations (e.g., digital twin) In such cases, the sensors on the mobile robots 401 and the cameras 402 report on the sensor data to the controller/processor 430, 440 at the edge cloud 420 using UE to network communication instead of D2D communication.

This scenario is similar to the scenario shown in FIG. 3. In this scenario, sensor data needs to be collected in a synchronized way in real time to a controller/processor 430, 440 located at the edge cloud 420 for processing and deciding on the follow up control signaling 442. A late critical sensor data may also be responsible for a fail of the complete control cycle.

The disclosure introduces techniques for improving the performance of mobile communication networks with respect to resource utilization efficiency and control cycles losses. By applying methods and apparatus for group QoS control of multiple QoS flows as described hereinafter, such a fail of the complete control cycle and thus waste of resources as shown in FIG. 4 can be overcome.

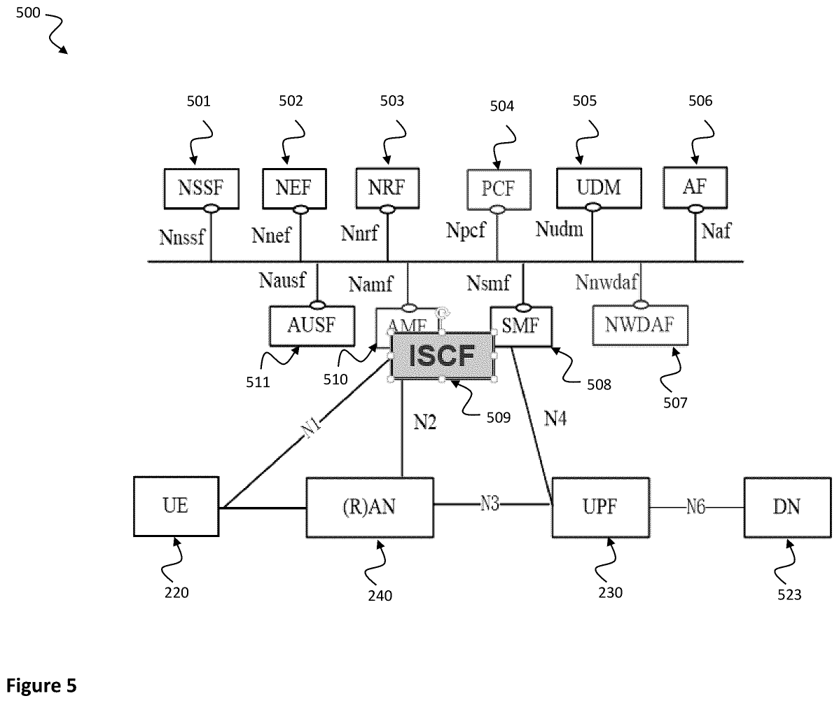

FIG. 5 shows a schematic diagram illustrating a mobile network architecture 500.

The mobile network architecture 500 comprises a user equipment (UE) 220 connected to a radio access network (RAN) 240 which is connected via N3 interface to user plane function (UPF) 230, e.g. as shown above with respect to FIG. 2. The UPF 230 is connected to data network (DN) via N6 interface.

The mobile network architecture 500 further comprises an access and mobility management function (AMF) 510, a session management function (SMF) 508, a network data analytics function (NWDAF) 507, an authentication server function (AUSF) 511, a network slice selection function (NSSF) 501, a network exposure function (NEF) 502, a network resource function (NRF) 503, a policy control function (PCF) 504, a unified data management (UDM) 505 and an application function (AF) 506 which are interconnected via a logical interface. AMF 510 may host an Inter Slice Communication Function (ISCF) 509.

The user equipment (UE) 220 is connected to AMF 510 via N1 interface and the RAN 240 is connected to AMF 510 via N2 interface.

While this mobile network architecture 500 as shown in FIG. 5 does not work in case of multiple QoS flows from different UEs and due to missing support for TSC (time sensitive communication) type service traffic which is fully synchronized and has periodic traffic pattern, the disclosure introduces techniques for enhancing the functionality of this mobile network architecture 500 which improves the performance with respect to resource utilization efficiency and control cycles losses. By applying methods and apparatus for group QoS control of multiple QoS flows as described hereinafter, the mobile network architecture 500 can be improved in order to avoid waste of resources as described above with respect to FIGS. 3 and 4.

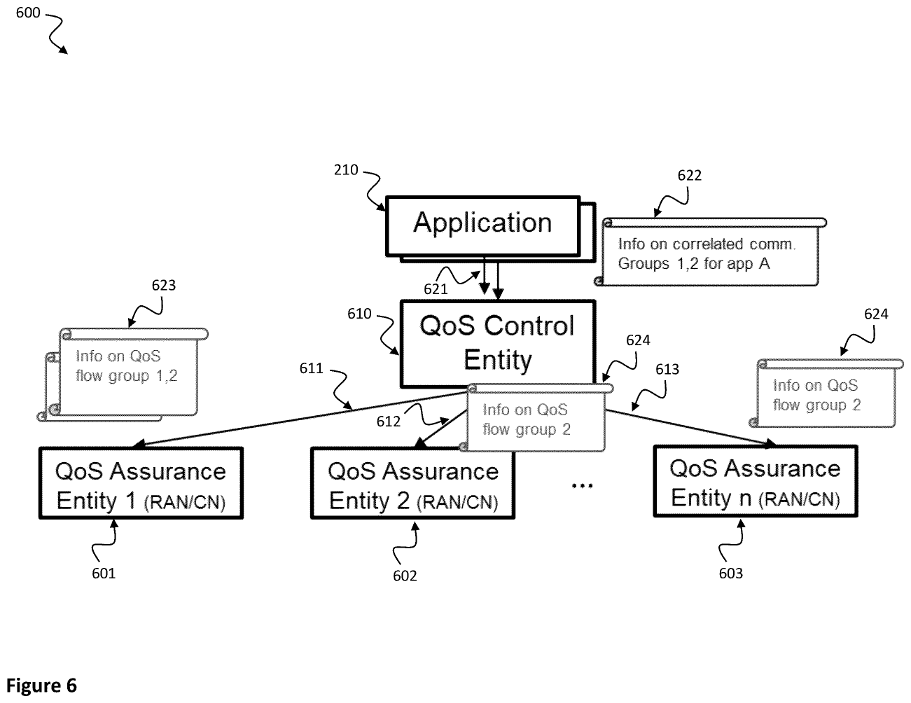

FIG. 6 shows a schematic diagram illustrating a mobile communication system 600 with QoS control entity and QoS assurance entities according to the disclosure.

The mobile communication system 600 comprises a QoS control entity 610 that receives information 622 on an exemplary number of two correlated communication groups (which could be also considered as a traffic group(s)) for application A via a first communication interface 621 to Application 210. The two correlated communication groups are only exemplary. Any other number of correlated communication groups may be used as well, for example 3, 4, 5, 6, 7, 8, 9, 10 or more correlated communication groups. The QoS control entity 610 comprises a second communication interface 611, 612, 613 for providing information 623 on QoS flow group 1, 2 to a first QoS Assurance entity 601 and providing information 624 on QoS flow group 2 to a second QoS Assurance entity 602 and a third QoS Assurance entity 603. The number of QoS Assurance entities 601, 602, 603 is exemplary chosen as three. Any other number of QoS Assurance entities can be applied as well. The number of QoS flow groups is exemplary chosen as being two. Any other number of QoS flow groups can be applied as well. The QoS control entity 610 may receive information on correlated communication groups from more than one application via the first communication interface. Each application are treated independent to each other same as described above.

In FIG. 6, the involved network entities and also the interactions between them to enable group QoS control of multiple QoS flows are illustrated. The mobile communication system 600 comprises a QoS Control Entity 610 and an exemplary number of three QoS assurance entities 601, 602, 603.

In the following, the functionalities of the entities in FIG. 6 are described in detail.

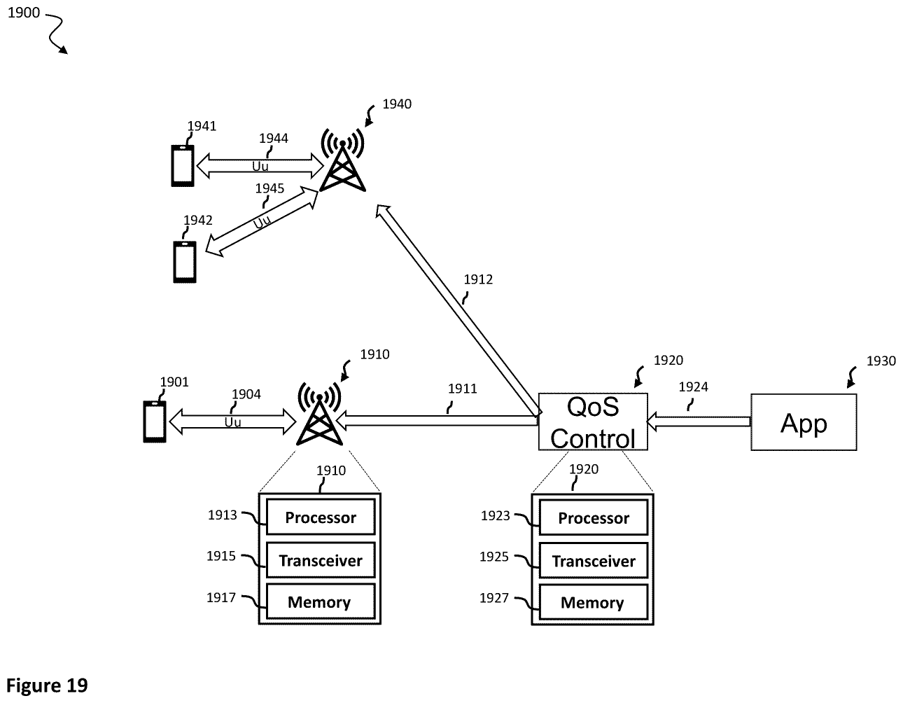

The control entity 610 comprises a first communication interface configured to obtain group Quality of Service, QoS, treatment requirement(s) 621 for group QoS treatment of a traffic group comprising one or more communication services in the mobile communication network 600. The first communication interface may correspond to the transceiver 1925 described below with respect to FIG. 19. The first communication interface may correspond to an electrical line for signaling between two network entities, i.e. not via radio interface.

The control entity 610 comprises a processor configured to generate one or more QoS flow groups and a corresponding group QoS treatment policy for each QoS flow group based on the obtained group QoS treatment requirement(s) 621 and the traffic group. Each QoS flow group comprises at least one of the one or more communication services. The processor may correspond to the processor 1923 described below with respect to FIG. 19.

The control entity 610 comprises a second communication interface configured to provide QoS group information 611, 612, 613 to one or more network entities 601, 602, 603, for example, QoS assurance network entities 601, 602, 603 in the mobile communication network 600. The QoS group information 611, 612, 613 comprises a QoS flow group identifier, QFGI, and the group QoS treatment policy for the respective QoS flow group. The second communication interface may correspond to the transceiver 1925 described below with respect to FIG. 19.

The processor may be configured to assign a corresponding QoS flow group identifier (QFGI) to the one or more QoS flow groups.

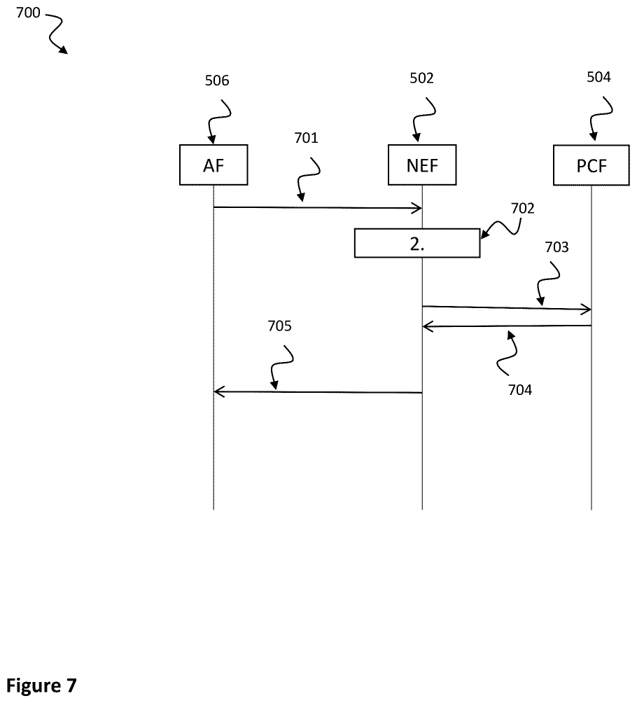

The group QoS treatment requirement(s) 621 can be obtained directly from Application layer 210 or obtained from the Application layer 210 via a network entity, for example, an Application Function, AF, and/or a Network Exposure Function, NEF, and/or a Unified Data Repository, UDR, e.g. as described below with respect to FIGS. 7 to 11.

The group QoS treatment requirement(s) 621 can be obtained together with a traffic group identifier of the traffic group directly from the Application layer 210 or from the Application layer 210 via a network entity, for example, an AF and/or a NEF, e.g. as described below with respect to FIGS. 7 to 11. The traffic group identifier is identifying the traffic group.

A traffic group identifier of the traffic group can be obtained directly from the Application layer 210 or from the Application layer via a network entity, for example, an AF and/or a NEF, e.g. as described below with respect to FIGS. 7 to 11. The group QoS treatment requirement(s) 621 can be obtained from a database, for example, a 5G Unified Data Repository, UDR, entity, e.g. as described below with respect to FIGS. 7 to 11. The traffic group identifier is identifying the traffic group.

The group QoS treatment policy comprises at least one of: a percentage of communication services of the one or more communication services in the QoS flow group of which the QoS needs to be fulfilled, or a percentage of communication services of the one or more communication services in the QoS flow group of which the QoS does not need to be fulfilled, a percentage of communication services in the QoS flow group to be treated as a whole for group resource management, a parameter controlling a fair chance of QoS fulfillment and/or group resource management for each communication service within the QoS flow group, an indication of an allowed communication latency threshold with respect to a number of control cycles, a parameter for aligning arrival time at the receiver, e.g. as described below with respect to FIGS. 7 to 11.

The group QoS treatment requirement(s) comprise at least one of: a percentage of communication services of the one or more communication services in the traffic group of which the QoS needs to be fulfilled, or a percentage of communication services of the one or more communication services in the traffic group of which the QoS does not need to be fulfilled, a percentage of communication services in the traffic group to be treated as a whole for group resource management, a parameter controlling a fair chance of QoS fulfillment and/or group resource management for each communication service within the traffic group, an indication of an allowed communication latency threshold with respect to a number of control cycles, a parameter for aligning arrival time at the receiver, e.g. as described below with respect to FIGS. 7 to 11.

A group resource management policy is a policy for the group resource management. This group resource management policy may comprise at least one of: combined admission control, for example, during QoS Flow establishment or handover, combined smart resource scheduling at Radio Access Network, RAN, e.g. as described below with respect to FIGS. 7 to 11.

The group QoS treatment policy and/or the group QoS treatment requirement(s) may further comprise parameters and/or information dedicated for the group QoS treatment, wherein the parameters and/or information dedicated for the group QoS treatment comprise at least one of: validating conditions of the group QoS treatment, for example, minimum group size, temporal validity condition, spatial validity condition, group QoS treatment pattern, for example, execution of group QoS treatment periodically or in a flow life time, e.g. as described below with respect to FIGS. 7 to 11.

The second communication interface may be configured to provide the QoS group information 611, 612, 613 together with a QoS profile per QoS flow to the QoS assurance network entities 601, 602, 603 based on Session Management, SM and/or policy association procedure, e.g. as described below with respect to FIGS. 7 to 11.

The second communication interface may be configured to provide the QoS group information 611, 612, 613 together with a QoS profile per QoS flow to the QoS assurance network entities 601, 602, 603 based on Session Management, SM, procedure via Access and Mobility management Function, AMF, entity, e.g. as described below with respect to FIGS. 7 to 11.

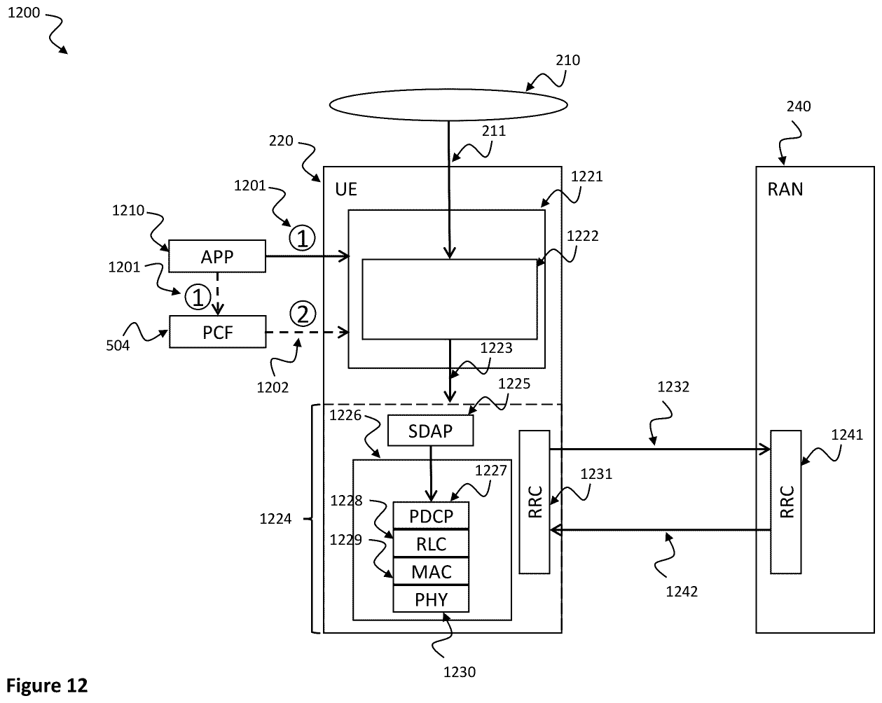

The control entity 610 may be implemented as a network function entity 610 of a 5G mobile communication network or embedded within a 5G Policy Control Function entity and/or a 5G Network Exposure Function entity of the 5G mobile communication network, e.g. as described below with respect to FIGS. 7 to 11. Alternatively, the control entity 610 may be implemented within a user device, e.g. as described below with respect to FIG. 12.

The second communication interface of the control entity 610 that is implemented within a user device may be configured to provide the QoS group information 611, 612, 613 together with a QoS profile per QoS flow to a Radio Access Network entity of the mobile communication network via Radio Resource Control signaling, e.g. as described below with respect to FIG. 12.

The network entities 601, 602, 603 shown in FIG. 6 may be or may include QoS assurance entities 601, 602, 603 for assuring Quality of Service of a traffic group comprising one or more communication services of one or more UEs in the mobile communication network 600, e.g. as described below with respect to FIGS. 7 to 11.

Such a network entity 601, 602, 603 comprises a communication interface configured to receive QoS group information 611, 612, 613, the QoS group information 611, 612, 613 comprising a QoS flow group identifier (QFGI) and a group QoS treatment policy for a respective QoS flow group comprising one or more communication services of the mobile communication network 600. The communication interface may correspond to the transceiver 1915 described below with respect to FIG. 19.

The network entity 601, 602, 603 further comprises a processor configured to process a communication service of the mobile communication network 600 that is assigned to the QoS flow group based on the group QoS treatment policy. The processor may correspond to the processor 1913 described below with respect to FIG. 19.

The QoS group information 611, 612, 613 may comprise a QoS Flow group identifier, QFGI, assigned to the QoS flow group.

The group QoS treatment policy for a respective flow group may comprise at least one of: a percentage of communication services of the one or more communication services in the respective QoS flow group and/or traffic group of which the QoS needs to be fulfilled, or a percentage of communication services of the one or more communication services in the respective QoS flow group and/or traffic group of which the QoS does not need to be fulfilled, a percentage of communication services in the QoS flow group and/or traffic group to be treated as a whole for group resource management, a parameter controlling a fair chance of QoS fulfillment and/or group resource management for each communication service within the respective QoS flow group and/or traffic group, an indication of an allowed communication latency threshold with respect to a number of control cycles, a parameter for aligning arrival time at the receiver, e.g. as described below with respect to FIGS. 7 to 11.

A group resource management policy is a policy for the group resource management. Such group resource management policy may comprise at least one of: combined admission control, for example, during QoS Flow establishment or handover, combined smart resource scheduling at Radio Access Network, RAN, e.g. as described below with respect to FIGS. 7 to 11.

The group QoS treatment policy for a respective QoS flow group may further comprise parameters and/or information dedicated for the group QoS treatment, wherein the parameters and/or information dedicated for the group QoS treatment comprise at least one of: validating conditions of the group QoS treatment, for example, minimum group size, temporal validity condition, spatial validity condition, group QoS treatment pattern, for example, execution of group QoS treatment periodically or in a flow life-time, e.g. as described below with respect to FIGS. 7 to 11.

The processor may be configured to assign resources, perform smart scheduling, perform admission control, Perform QoS assurance of the mobile communication network to the communication service based on the group QoS treatment policy and a QoS profile of a QoS flow assigned to the communication service, e.g. as described below with respect to FIGS. 7 to 11.

The network entity 601, 602, 603 may comprise a Radio Access Network entity and/or a Core Network entity, for example, a Session Management Function entity of a 5G mobile communication network, e.g. as described below with respect to FIGS. 7 to 11.

The QoS group information 611, 612, 613 can be part of a Quality of Service profile assigned to the communication service, e.g. as described below with respect to FIGS. 7 to 11.

The processor may be configured to process the communication service of the mobile communication network based on the Quality of Service profile assigned to the communication service if the QoS group information 611, 612, 613 is unavailable or unknown to the processor.

The communication system of FIG. 6 represents a system 600 for group QoS control of multiple QoS flows, the system comprising: a control entity 610 as described above for controlling one or more communication services of a mobile communication network 600; and one or more network entities 601, 602, 603 as described above for assuring Quality of Service of one or more communication services of the mobile communication network 600.

The QoS Control Entity 610 may for example be embedded within a PCF, e.g. PCF 504 illustrated in FIG. 5. The QoS Control Entity 610 obtains the requirement(s) of group QoS treatment of multiple service traffic in certain communication group (e.g., from the application layer), i.e.: Application ID, traffic group ID, correlated communication traffic description in the communication group (e.g., source/destination UE ID/layer-2 ID and QoS requirements for each traffic flow), correlated QoS treatment requirement(s) (e.g., joint fulfillment, synchronized fulfillment, fair fulfillment) and related parameters. The QoS Control Entity 610 generates one or more correlated QoS flow group and related Group QoS treatment policy per QoS assurance entity based on the obtained information of the communication group. The QoS Control Entity 610 provides the QoS Group Information (includes Group QoS treatment policy, QFGI) to the correspondent QoS assurance entities 601, 602, 603.

The QoS Assurance Entities 601, 602, 603 (e.g., RAN, SMF) receive the QoS Group Information from the QoS control network entity 610. The QoS Assurance Entities 601, 602, 603 proceed joint QoS treatment per QoS flow group based on QoS Group Information and QoS profile.

One or more embodiments of the present disclosure are related to the following methods and apparatuses: A method and apparatus to implement the “Group QoS profile” on top of the current QoS profile (flow level), i.e., a definition of QoS Group Information which includes QoS Flow Group ID, Group QoS treatment policy and related parameters. A method and apparatus (i.e., QoS control entity 610) to determine the QoS Group Information per QoS assurance entity based on the information on the correlated communication group from the application layer 210. A method and apparatus to provide the QoS Group Information from the QoS control entity 610 to one or more QoS assurance entities 601, 602, 603. Methods and apparatuses for group QoS treatment at the QoS assurance entity 601, 602, 603 based on QoS Group Information.

Exemplary embodiments and implementation examples of these methods and apparatuses are described in the following sections.

### Group QoS Treatment Policy and Parameters

The group QoS treatment policy (or policies) can be either group QoS fulfillment policy or group resource management policy. For an exemplary implementation, it can be categorized as joint QoS fulfillment, synchronized QoS fulfillment, fair QoS fulfillment, etc. Each example Group QoS treatment policy can be implemented with an indication of the Group QoS treatment policy category and additional parameters used by the policy (e.g., percentage of joint QoS fulfillment; to be synchronized QoS attributes (e.g., PDB, priority, AQP level) and a variance which is allowed for synchronized QoS fulfillment (e.g., ±5%). This disclosure does not limit the actual form of implementation of Group QoS treatment policy.

### Examples of Group QoS Fulfillment Policy (Policies) are as Follows

Guarantee the QoS requirement of 70% of the QoS flows in this QoS flow group. RAN would have the freedom to select the QoS flows in this QoS flow group to be dropped based on the actual radio condition, e.g., in case application layer can tolerate certain percentage of lost information such as duplicated/correlated data from multiple sensors.

2) Prioritization of QoS Flows within the QoS Flow group to ensure the handling of the most important traffic (e.g. main sensor) during temporary resource shortages.

3) Each QoS flow in the group should give a fair chance of QoS fulfillment in case of temporary resource shortages (e.g., this can be used in case the application would like to get heterogeneous reading from multiple sensor sources).

4) Align the fulfilled Alternative QoS Profile (AQP) level for all QoS flows in the group. E.g., AQP level 1 corresponds to allowed communication latency to meet the deadline with one control cycle, AQP level 2 corresponds to allowed communication latency to meet the deadline with two control cycles, etc.

### Examples of Group Resource Management Policy (Policies) are as Follows

Combined admission control (during QoS Flow establishment, handover). E.g., admit the QoS flows considering the QoS requirements of all the QoS flows in this QoS flow group. If any one of them could not be satisfied, drop all (i.e., give the resource of all the QoS flows in this group to some other QoS flows). If QoS requirement of flow 1 (e.g., critical sensor reading) cannot be satisfied, drop all.

2) Combined smart resource scheduling at RAN. E.g., resource allocation considering the QoS requirements of all the QoS flows in this QoS flow group for a certain control cycle. E.g., prioritize the resource scheduling for the QoS flow taking less radio resource in the QoS flow group in case of radio resource shortage.

The QoS Group information may include additional parameters specifying the usage of the Group QoS treatment policy, e.g.: 1) Validating conditions of the Group QoS treatment policy, e.g., minimum group size (e.g., >5), temporal validity condition (e.g., 14:00-15:00, day, workday), spatial validity condition (e.g. indicated by Cell ID or Tracking Area ID), etc.; 2) Pattern to apply Group QoS treatment policy, e.g., in the life time of the QoS flow, or periodical. In case the pattern is periodical, the parameter may also include indication of the starting time/ending time, and/or length of the communication cycle/transfer interval.

In the following, an example of the usage of different QoS flow group treatment pattern is presented:

Apply QoS group treatment policy in the life-time of the QoS flow for admission control or PDU session management. E.g., RAN admits the QoS flows only in case the QoS requirements of all the QoS flows in the group can be satisfied during the handover. i.e., group handover only, no handover of individual QoS flow. SMF decides on the PDU session establishment/modification only if the QoS requirements of all the QoS flows in the same group can be satisfied.

2) Apply QoS group treatment policy periodically for smart resource scheduling at RAN. E.g., do not allocate the resource for any QoS flows in a group in one “control cycle” unless the QoS requirements of all of them can be fulfilled. Prioritize/select the “more valuable” flows in the group for QoS fulfillment in case of resource shortage in one “control cycle” for all the flows. A “more valuable” flow can be the one more critical from the application point of view, or the one that consumes less radio resources comparing to the other ones in the same group. Align the scheduling of the QoS flows in a group to ensure that they can all reach the receiver (e.g., controller) almost at the same time (within the deadline while not consume extra resource which is not necessary).

### Embodiment for Uu QoS Case

In Uu (i.e., UE to network communication) QoS case, the QoS control entity can be implemented as a new NF or embedded in an existing NF. In the following sections, the embodiment is illustrated the QoS control entity is embedded in PCF.

### Determine the QoS Group Information (Uu QoS Case)

The PCF needs to get the group QoS requirement(s) as well as the description of the traffic flows in the group from the application layer. The group QoS requirement(s) can be, for example, joint QoS fulfillment, synchronized QoS fulfillment and fair QoS fulfillment. The traffic flows belonging to an application layer group may be bound to a “group QoS profile” derived from the application layer group QoS requirement(s).

The binding of the traffic flows to a group can be configured at the PCF or NEF per application by the OAM (e.g., using a mapping table). The group QoS requirement(s) may also be configured per application at the PCF or NEF or UDR by the OAM.

The following details show the implementation options where the PCF gets the group QoS requirement(s) and group membership information from the AF (via NEF and/or UDR).

It is noted that the group QoS treatment requirement 621 and/or traffic group identifier may also be obtained from the application layer via a management entity. In this case, also known as preconfigured case, the following interactions can be skipped. This means:

In case the group QoS requirement(s) and group membership information are configured by the OAM at the PCF, the following interactions can be skipped.

In case the group QoS requirement(s) and group membership information are configured by the OAM at the NEF or UDR, the following interactions between AF and NEF, UDR can be skipped.

This example reuses the current procedure of “setting up an AF session with required QoS” to get description of each QoS flow and their mapping to a group. Two new parameters are defined for the interaction between AF and PCF in addition to the existing QoS requirements of individual QoS flow: 1) Application traffic group ID; and 2) Group QoS requirement(s), which are indicating the requirement(s) on how the QoS flows in this group should be jointly treated from the application layer.

There are two implementation options for PCF how to obtain the description of the QoS flows in a group and the group QoS flow requirement(s) from the AF. These two implementation options are described in the following with respect to FIGS. 6, 7 and 8.

FIG. 7 shows a message sequence chart 700 illustrating an exemplary procedure of “setting up an AF session with required QoS” according to a first option (option 1) according to the disclosure.

Option 1 is to provide external traffic group ID, Group QoS requirement(s) together with flow QoS requirement(s) for each QoS flow by utilizing the procedure of “setting up an AF session with required QoS” as shown in FIG. 7 and described below.

In the message sequence chart 700 messages between AF 506, NEF 502 and PCF 504 are exchanged. These network entities AF 506, NEF 502 and PCF 504 may correspond to the 5G mobile network architecture 500 as illustrated in FIG. 5.

In step 1 (“Nnef AFsessionWithQoS_Create request (QoS flow descriptions and QoS req., external traffic group ID, Group QoS requirement(s), etc.)”) 701, AF 506 sends per traffic flow a request for, setting up an AF session with required QoS” to NEF 502, e.g., AF session With QoS create request, with QoS flow descriptions and QoS requirements, and additional external traffic group ID and Group QoS requirement(s) (as shown in example below). The group QoS requirement(s) are only provided for the first AF request for the QoS flow in the same group. In step 2 (“Authorization”) 702, NEF 502 authorizes the request, and may optionally perform a mapping between external traffic group ID and internal traffic group ID. Upon a successful authorization, NEF 502 provides list of QoS flows descriptions and QoS requirements together with the traffic group ID and group QoS requirement(s) to PCF 504 in a policy creation request, e.g., PolicyAuthorization_Create request in step 3 (“Npcf_Policy Authorization_Create request (QoS flow descriptions and QoS req., traffic group ID, Group QoS requirement(s), etc.)”) 703. In step 4 (“Npcf_Policy Authorization_Create response”) 704, PCF 504 indicates the results of policy creation request to NEF 502. In step 5 (“Nnef_AFsessionWithQoS_Create response”) 705, NEF 502 indicates the results of, setting up an AF session with required QoS” to AF 506.

### Example Implementations of Step 1 (701) and Step 3 (703) can be as Follows

Step 1: The AF 506 sends a request to setup an AF session for influencing the QoS of a traffic flow using Nnef_AFsessionWithQoS_Create request message (AF Identifier, UE address, Flow description(s), QoS reference, (optional) Alternative Service Requirements (containing one or more QoS reference parameters in a prioritized order), external traffic group ID, Group QoS requirement(s)) to the NEF 502.

Step 3: The NEF 502 interacts with the PCF 504 by triggering a Npcf PolicyAuthorization_Create request and provides AF Identifier, UE address, Flow description(s), the QoS reference, and the optional Alternative Service Requirements (containing one or more QoS reference parameters in a prioritized order), and traffic group ID and Group QoS requirement(s).

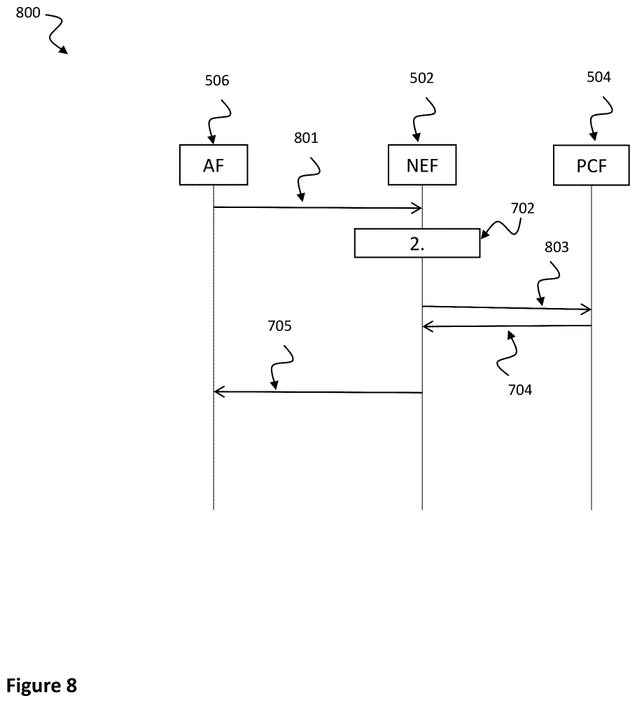

FIG. 8 shows a message sequence chart 800 illustrating an exemplary procedure of “setting up an AF session with required QoS” according to a second option (option 2) according to the disclosure.

Option 2 that may be a preferred implementation, is to provide external traffic group ID together with flow QoS requirements for each QoS flow by providing the group QoS rule as in a separate procedure as shown in FIG. 8 and described below.

In the message sequence chart 800, messages between AF 506, NEF 502 and PCF 504 are exchanged. These network entities AF 506, NEF 502 and PCF 504 may correspond to the 5G mobile network architecture 500 as illustrated in FIG. 5.

Compared to option 1, step 1 (“Nnef_AFsessionWithQoS_Create request (QoS flow descriptions and QoS req, external traffic group ID, etc.”) 801 and step 3 (“Npcf_Policy Authorization_Create request (QoS flow descriptions and QoS req., traffic group ID, etc.)” 803 of the procedure of “setting up an AF session with required QoS” only includes the additional information of external traffic group ID.

### Example Implementations of Step 1 (801) and Step 3 (803) can be as Follows

Step 1: The AF sends a request to setup an AF session for influencing the QoS of a traffic flow using Nnef_AFsessionWithQoS_Create request message (AF Identifier, UE address, Flow description(s), QoS reference, (optional) Alternative Service Requirements (containing one or more QoS reference parameters in a prioritized order), external traffic group ID) to the NEF.

Step 3: The NEF 502 interacts with the PCF 504 by triggering a Npcf PolicyAuthorization_Create request and provides AF Identifier, UE address, Flow description(s), the QoS reference, and the optional Alternative Service Requirements (containing one or more QoS reference parameters in a prioritized order), and traffic group ID.

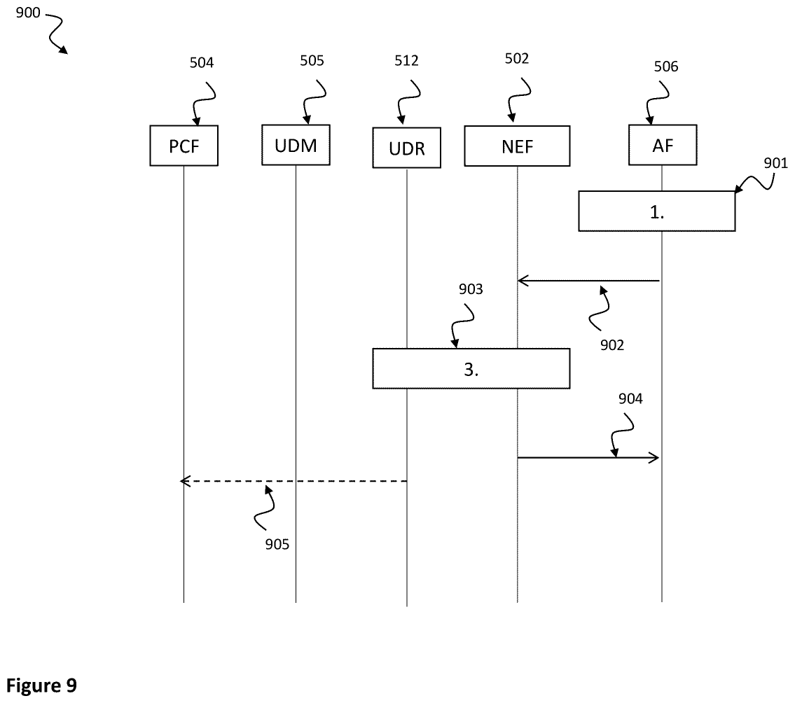

FIG. 9 shows a message sequence chart 900 illustrating an exemplary procedure of “set a policy for a future AF session” according to the second option (option 2) according to the disclosure.

In the message sequence chart 900, messages between PCF 504, UDR 512, NEF 502 and AF 506 are exchanged. These network entities PCF 504 UDR 512, NEF 502 and AF 506 may correspond to the 5G mobile network architecture 500 as illustrated in FIG. 5. UDM 505 is optional to the embodiment of FIG. 9.

Group QoS requirement(s) are provided with the procedure of “set a policy for a future AF session” as shown in FIG. 9. When AF 506 creates an AF request, e.g. in step 1 (“Creation of the AF request”) 901, and requests to set a policy, it includes additional information of Group QoS requirement(s) and external traffic group ID in the request to NEF, e.g. as shown in step 2 (“Nnef_ApplyPolicy_Create (external traffic Group ID, Group QoS requirement(s))”) 902. In step 3 (“Storing/Updating/Removing the information”) 903, NEF 502 stores the group QoS requirement(s) and traffic group ID in the UDR 512 after the authorization and optionally a conversion between external traffic group ID to an internal traffic group ID. Upon the feedback from UDR 512 on information storage, NEF 502 responses to AF 506 in step 4 (“Nnef_ApplyPolicy_Create Response”) 904. Afterwards, PCF 504 can retrieve the stored group QoS requirement(s) and traffic group ID using step 5 (“Nudr_DM_Notify (traffic Group ID, Group QoS requirement(s))”) 905.

AF 506 provides Group QoS requirement(s) together with the External traffic group ID as shown in Table 1 below) for future AF session in UDR 512.

TABLE 1
Group QoS requirement(s) for an external flow group

| Parameters | Description |
|---|---|
| Group QoS requirement(s) | Indicates the group QoS requirement(s) which |
| | should be applied to this flow group from the |
| | application layer |
| External traffic group ID | An identifier for 5G QoS flow group |

The table stored in UDR has the same form potentially with the external traffic group ID replaced by traffic group ID. UDR stores such a table per traffic group per application.

Based on the group membership information (e.g., indicated by traffic group ID) and group QoS requirement(s) from the application layer, PCF 504 generates splitted QoS flow groups for each involved assurance entity and assigns a QFGI for each splitted QoS flow group. Each further splitted group may have the same QFGI (or different QFGI if the assurance entity needs to differentiate the treatment of the QoS flow moves from other assurance entity, e.g., due to UE mobility). The splitted group may have the same Group QoS treatment policy as the one derived directly from the Group QoS requirement(s) from the application layer or a different group QoS treatment policy due to the split (e.g., packet delay budget PDB providing to different RAN can be different based on the CN-PDB of different RAN to the edge cloud. RAN PDB=end to end PDB from the application requirements—CN-PDB).

### Procedure and Signaling for the Provision of QoS Group Information (Uu QoS Case)

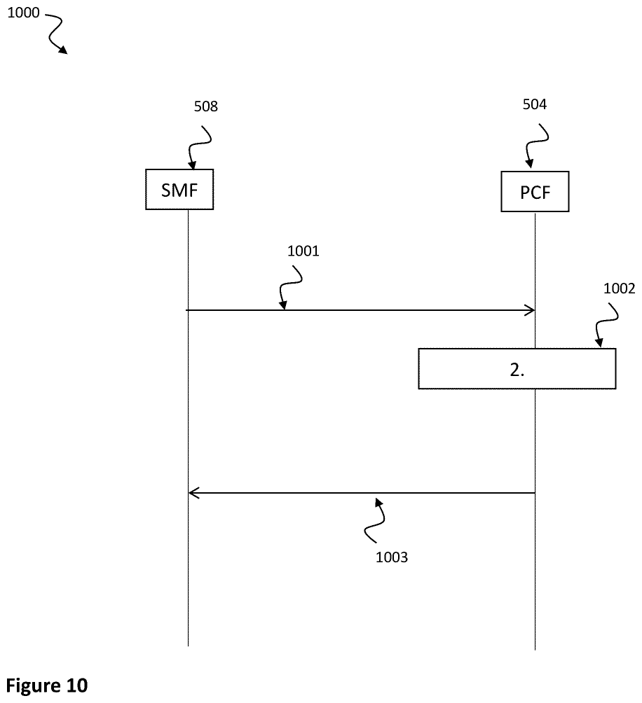

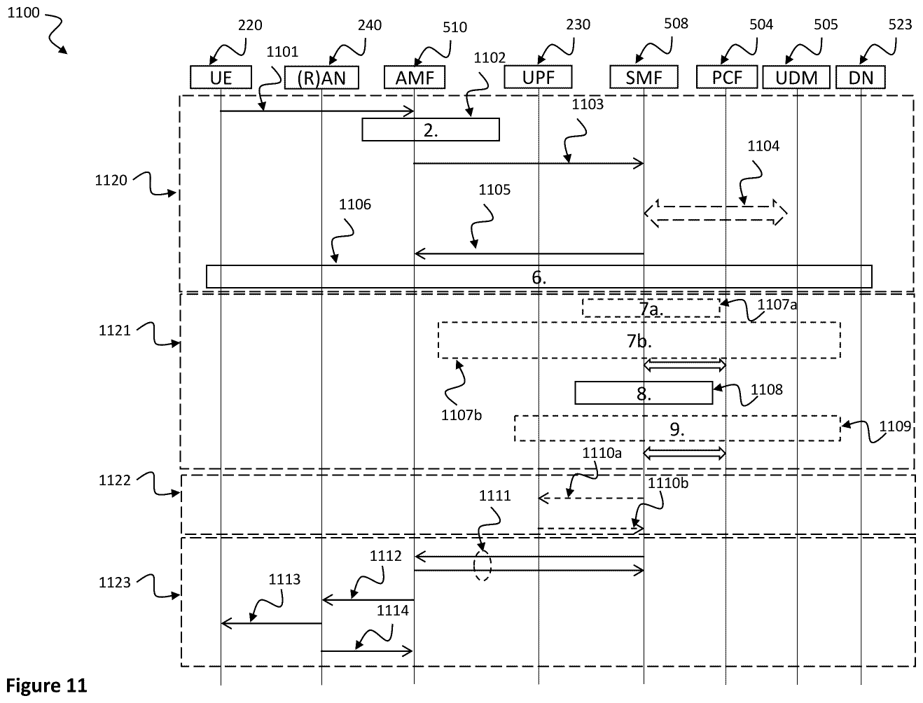

In the following FIGS. 10 and 11, provision of QoS group information is shown for the Uu QoS case.

PCF 504 provides the QoS Group information to SMFtogether with the QoS profile of each QoS flow using the existing Session management (SM) policy association procedure.

FIG. 10 shows a message sequence chart 1000 illustrating an exemplary SMF policy association establishment procedure according to the disclosure.

In the message sequence chart 1000, messages between SMF 508 and PCF 504 are exchanged. These network entities SMF 508 and PCF 504 may correspond to the 5G mobile network architecture 500 as illustrated in FIG. 5.

In step 1 (“Npcf SMPolicyControl_Create”) 1001, SMF 508 transmit a create request to PCF 504. In step 2 (“Policy decision”) 1002, the policy decision is made by PCF 504 and in step 3 (“Npcf SMPolicyControl_Create Response (QFI(s), QoS profile(s), QoS group info . . . )”) 1003, a create response is transmitted from PCF 504 to SMF 508.

QoS Group information is provided only once per QoS flow group per QoS enforcement entity (e.g., RAN, SMF).

SMF 508 obtains the QoS Group information (i.e., QFGI, group treatment policy, etc.) from the PCF 504 using SMF policy association establishment procedure (e.g., as a response from the PCF on a SM policy control creation request shown in step 3 in FIG. 10) or SMF policy association modification procedure.

SMF 508 further provides QoS Group information to RAN via AMF as part of Session Management (SM) information using PDU session establishment procedure or PDU session modification procedure.

FIG. 11 shows a message sequence chart 1100 illustrating an exemplary PDU session establishment procedure according to the disclosure.

In the message sequence chart 1100, messages between UE 220, RAN 240, AMF 510, UPF 230, SMF 508, PCF 504, UDM 505 and DN 523 are exchanged. These network entities UE 220, RAN 240, AMF 510, UPF 230, SMF 508, PCF 504, UDM 505 and DN 523 may correspond to the 5G mobile network architecture 500 as illustrated in FIG. 5.

1n a first step (“PDU Session Establishment Request”) 1101, PDU session establishment is requested by UE 220 to AMF 510. In a second step (“SMF selection”) 1102, AMF 510 selects a SMF and transmits in a third step (“Nsmf PDUSession_CreateSMContext_Request”) 1103 a corresponding message to SMF 508 to request creation of SM context. In a fourth step (“Subscription retrieval/Subscription for update”) 1104, SMF 508 retrieves or updates subscription from UDM 505. In a fifth step (“Nsmf PDUSession_CreateSMContext Response”) 1105, SMF responds to AMF 510. In a sixth step (“PDU Session authentication/authorization”) 1106, the session is authenticated and authorized. These first seven steps belong to a first message sequence 1120 “UE trigger PDU session establishment and SM context creation”.

In step 7a (“PCF selection”) 1107a, PCF is selected. In step 7b (“SM Policy Association Establishment or SMF initiated SM Policy Association Modification”) 1107b, a policy is established or modified. In step 8 (“UPF selection”) 1108, UPF is selected. In step 9 (“SMF initiated SM Policy Association Modification”) 1109, a policy association is modified. These steps 7a to 9 belong to a second message sequence 1121 “SMF gets the policy (include QoS group info) from PCF on the PDU session”. Details of Step 7b and step 9 are the same as described in FIG. 10.

In step 10a (“N4 Session Establishment/Modification Request”) 1110a, a N4 session is established or modified. In step 10b (“N4 Session Establishment/Modification Response”) 1110b, a response to step 10a is sent from UPF 230 to SMF 508. These steps 10a and 10b belong to a third message sequence 1122 “SMF triggers UPF resource adjustment according to the policy from PCF”.

In step 11 (“Namf_Communication_N1N2Message Transfer (QoS profile(s), QFI(s), QoS group info . . . )”) 1111, QoS data is transmitted from SMF 508 to AMF 510. In step 12 (“N2 PDU Session Request (NAS msg, QoS group info . . . )”) 1112, a PDU session request is transmitted from AMF 510 to RAN 240. In step 13 (“AN-Specific resource setup (PDU Session Establishment Accept)”) 1113, resources are set up between RAN 240 and UE 220. In step 14 (“N2 PDU Session Response”) 1114, a response to PDU session request is transmitted from RAN 240 to AMF 510. These steps 11 to 14 belong to a fourth message sequence 1123 “SMF triggers RAN resource adjustment according to the policy from PCF”.

FIG. 11 shows the example that SMF 508 provides the QoS group information to RAN 240 in the PDU session establishment procedure.

From step 1 to 6 (1120), UE 220 triggers PDU session establishment and SM context creation in the network by sending a PDU session establishment request to AMF 510.

From Step 7 to step 9 (1121), SMF 508 gets the policy (include QoS group information for each QoS flow in the PDU session) from the PCF 504 on this PDU session.

In step 10a and 10b (1122), SMF 508 may trigger UPF 230 resource adjustment according to the policy from PCF 504 (including QoS group information).

In step 11 (1111), SMF 508 provides the QoS group information (i.e., QFGI, group treatment policy) together with the QoS profile(s) and QFI(s) to AMF 510 as part of N2 SM information, AMF 510 provides the N2 SM information further to RAN 240 in step 12 (1112).

In steps 13 and 14 (1113, 1114), RAN 240 adjusts the resource accordingly and provides the response to AMF 510.

### Embodiment for PC5 QoS Case

FIG. 12 shows a schematic diagram illustrating a mobile communication system 1200 in PC5 QoS case where QoS control entity is located at the UE, with determining and provisioning of QoS group information according to the disclosure.

The mobile communication system 1200 comprises a UE 220 and a RAN 240 which are communicating with each other via RRC 1231 in UE 220 and RRC 1241 in RAN 240. RRC 1231 in UE 220 transmits a resource request (PC5 QoS info+QoS group info) message 1232 to RRC 1241 in RAN 240 which responds with an AS layer configuration+PC5 QoS flow mapping to RB message 1242.

The UE 220 comprises a middleware/V2X layer 1221 processing enhanced PC5 QoS rules (including packet filter set) supporting QoS group info 1222. The middleware/V2X layer 1221 receives application layer packets 211 from application layer 210. The enhanced PC5 QoS rules (including packet filter set) supporting QoS group info 1222 are processed via APP 1210 and PCF 504. Group QoS requirement(s) and group membership info from the application layer 1201 are transmitted from APP 1210 to middleware/V2X layer 1221 and to PCF 504. UE configuration to map application layer packets to PC5 QoS flows (with additional QoS group info) 1201 are transmitted from PCF 504 to middleware/V2X layer 1221.

Middleware/V2X layer 1221 transmits PC5 QoS flow (PFI, PC5 QoS info, +QoS group info) 1223 to UE AS layer 1224. UE AS layer 1224 includes SDAP 1225 and SL radio bearer 1226 including PDCP 1227, RLC 1228, MAC 1229 and PHY 1230 layers.

The embodiment of the concept of this disclosure as described above with respect to FIGS. 6 to 11 to the PC5 QoS case may be applied to the operation scenario 1 “NR SL Controlled by NR and 5GC” as described in TR 38.885 v16.0.0, and for example, for the NR SL Unicast Mode 1, where NR schedules SL resource(s) to be used by UE for SL (sidelink) transmission(s).

In PC5 case, either middleware/V2X layer 1221 at the UE 220 or PCF 504 can be the QoS control entity. RAN 240 is the QoS assurance entity. In case the QoS control entity is at the UE, RAN 240 obtain the QoS Group information from UE 220 via RRC signaling 1231, 1241.

### Determine and Provision of OoS Group Information (PC5 OoS Case)

QoS Control Entity at UEs 220 (e.g., V2X layer/UE middleware 1221) derives the QoS Group information (including QFGI, QoS group treatment policy, etc.) from the QoS group membership information and group QoS requirement(s) from the application layer 210 (as shown in FIG. 12 by the solid line 1201) and provides the QoS Group information together with the flow QoS profile to each UE AS layer 1224 (i.e., RRC 1231 in the control plane and PDCP 1227 in the data plane). The PDCP 1227 receives the PC5 QoS flow 1223 marked with additional QFGI information. The AS layer 1224 maintains a mapping table between the QFI, QFGI, and Group QoS treatment policy.

Alternatively, QoS Control Entity at PCF 504 derives the QoS Group information (including QFGI, QoS group treatment policy, etc.) from the QoS requirement(s) from the application layer 210 similar to what is described above with respect to FIGS. 7 to 9 with the difference that, PCF 504 does not further split the group per QoS assurance entity (i.e., there is always only one RAN 240 involved in this PC5 QoS case). PCF 504 provides the QoS Group information as part of UE configuration on the mapping between service traffic in the application layer 210 and QoS profile extended with QoS Group information to each UE 220 (as shown in FIG. 12 by the dotted line 1202). V2X layer/UE middleware 1221 performs the mapping and provides the QoS Group information together with the flow QoS profile to each UE AS layer 1224 (i.e., RRC 1231 and PDCP 1227).

### Procedure and Signaling for the Provision of OoS Group Information (PC5 OoS Case)

After QoS Control Entity (V2X layer/UE middleware 1221 or PCF 504) provides the QoS Group information to each UEs AS layer 1224 as described above, the UE 220 provides that to the QoS assurance entity (RAN 240) while establishing the PC5 QoS flow 1223 as follows:

The UE 220 provides PC5 QoS information, Destination Layer-2 ID(s) and communication mode to the NG-RAN and NG-RAN may provide AS layer configurations and configure the mapping of PC5 QoS flow to radio bearer.

The UE 220 provides PC5 QoS information (include QoS Group information) and Destination information (related to Destination Layer-2 ID(s)) to the NG-RAN for resource request.

The NG-RAN authorizes the UE-provided PC5 QoS information based on PCF-provisioned PC5 QoS parameters.

Middleware/V2X layer 1221 exists in each UE 220, they may communicate with each other using V5 reference interface and may communicate to V2X server using v1 reference interface. In this case, V2X server provides the mapping between service traffic in the application layer and QoS profile extended with QoS Group info to each UE via the communication in the V2X layer.

### “Group QoS Profile” Implemented as an Extended QoS Profile

In case the multiple QoS flows (with different packet filter and flow ID) in a QoS flow group have the same QoS profile, they can be bound to one QoS profile by the PCF 504. In this case, the QoS profile can be extended with additional QoS Group information as defined in this disclosure to enable group QoS treatment.

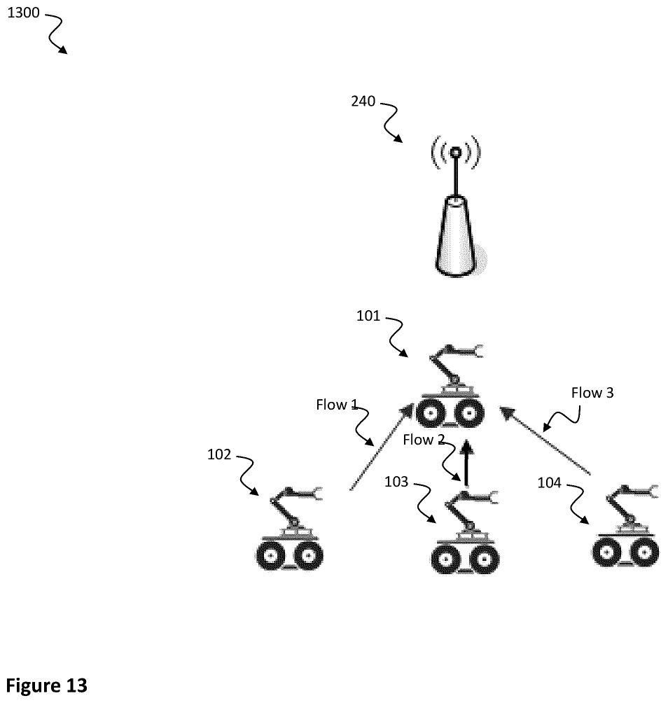

FIG. 13 shows a schematic diagram illustrating an exemplary D2D communication scenario 1300 with one cooperative group according to the disclosure. The first vehicle 101 is the controller while the other three vehicles 102, 103, 104 are controlled by the controller 101.

FIG. 13 is an example of Group QoS treatment at the QoS assurance entity based on QoS Group Information and QoS profile. In such an example of D2D group communication controlled by RAN 240 (mode 1), for the case in an industrial environment with four cooperative mobile robot/AGVs 101, 102, 103, 104, e.g. as shown in FIG. 1, carry large/heavy work pieces. The QoS flow group has three QoS flows (Flow 1, Flow 2, Flow 3).

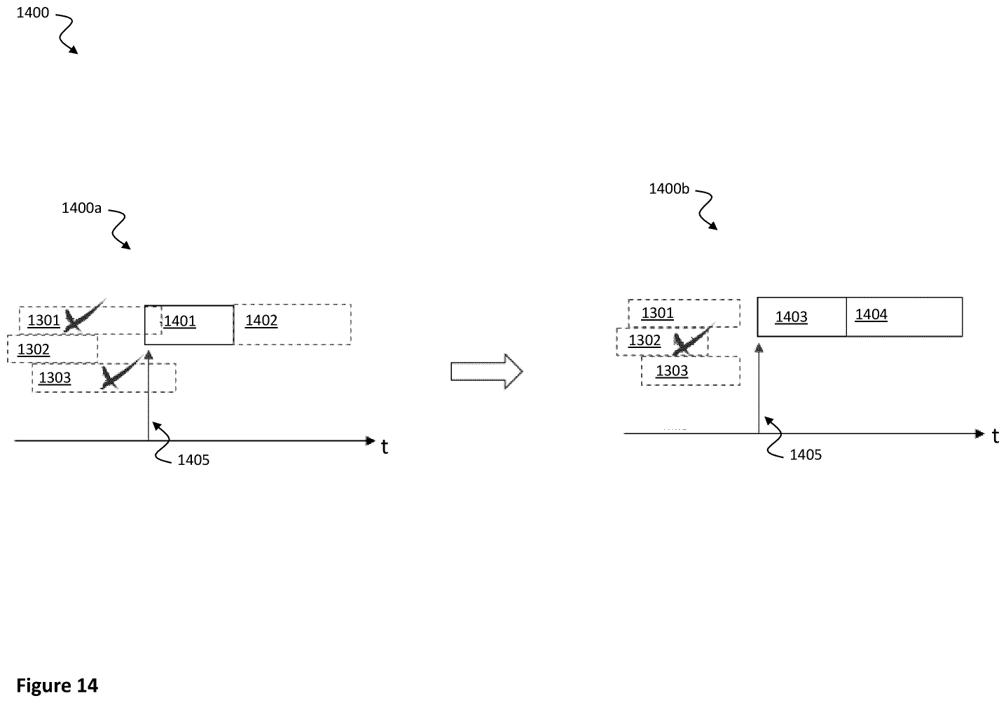

To further illustrate the exemplary scenario of group QoS treatment, FIGS. 14-18 are provided accordingly. The boxes in these figures refer to a slot or interval for corresponding actions. For example, feedback 1301 in FIGS. 14-16 and 18 refers to a slot for feed backing transmission. Feedback processing 1403 in FIG. 14 refers to a slot for processing the feedback.

FIG. 14 shows a schematic diagram illustrating an exemplary scenario 1400 of group QoS treatment using joint fulfillment according to the disclosure, on the left without group QoS treatment and on the right with group QoS treatment.

The left-hand diagram 1400a of FIG. 14 shows a timing for a first feedback 1301, a second feedback 1302 and a third feedback 1303, where the first and third feedback 1301, 1303 are finished after feedback deadline 1405. After feedback deadline 1405, a first lost slot 1401 (for feedback processing and control decision) and a second lost slot 1402 (for sending the control command) occur. This control cycle fails or is lost.

The right-hand diagram 1400b of FIG. 14 shows the timing for the first feedback 1301, the second feedback 1302 and the third feedback 1303, where the second feedback 1302 is dropped. After feedback deadline 1405, feedback processing 1403 and sending control message 1404 are performed. The time slot 1404 is for the transmission/sending the control message from the controller AGV to the controlled AGV.

The following scenario illustrates an example of diagram 1400 forJoint fulfillment intra-group resource coordination. This example can be described as follows:

Group QoS treatment policy: group QoS fulfillment policy, joint fulfillment, and at least two feedbacks need to be guaranteed.

Condition: Radio resource is insufficient for all the feedbacks 1301, 1302, 1303, if feedback 1302 is scheduled, neither feedback 1301 nor feedback 1303 can be scheduled at the same time. After feedback deadline 1405 a first lost slot 1401 (for feedback processing and control decision) and a second lost slot 1402 (for sending the control command) occur. This control cycle fails or is lost.

Action: RAN drops feedback 1302 (for example, RAN doesn't schedule transmission of a feedback(s) in the time slot). Effect: QoS of two feedbacks 1301, 1302 fulfilled instead of one feedback. After feedback deadline 1405, feedback processing 1403 and sending control message 1404, i.e. for sending the control message from the controller AGV to the controlled AGV can be performed in time.

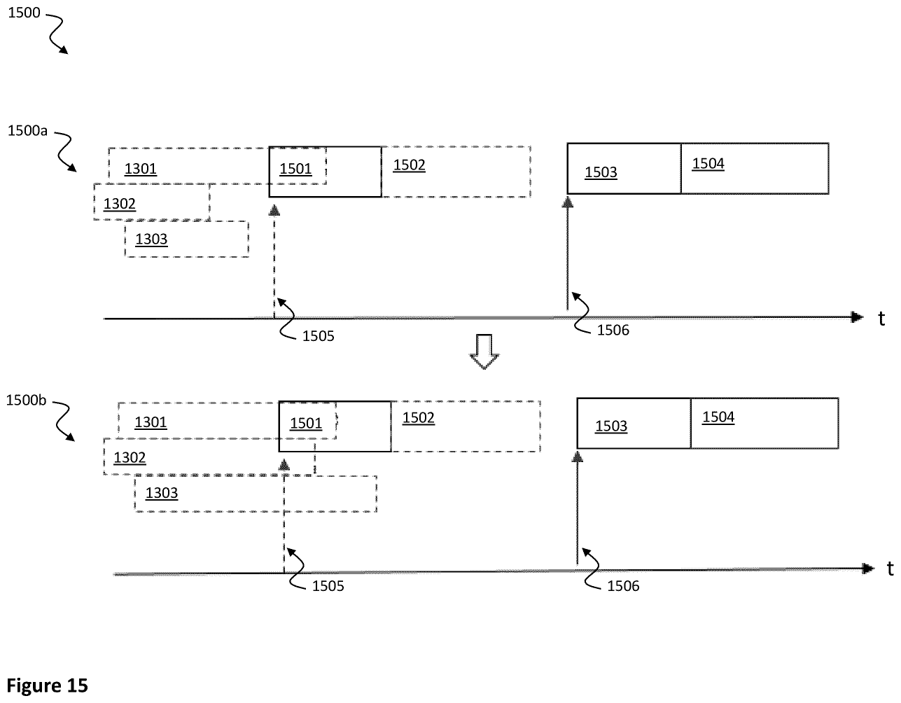

FIG. 15 shows a schematic diagram illustrating an exemplary scenario 1500 of group QoS treatment using aligned fulfillment according to the disclosure, on the upper part without group QoS treatment and on the lower part with group QoS treatment.

In the upper diagram 1500a of FIG. 15, a first feedback 1301, a second feedback 1302 and a third feedback 1303 occur. The first feedback 1301 is finished after feedback deadline 1505. After feedback deadline 1505 in the first control cycle, a first lost slot 1501 (for feedback processing and control decision) and a second lost slot 1502 (for sending the control command) occur. This first control cycle fails or is lost. After next feedback deadline 1506 in the second control cycle, feedback processing 1503 and sending control message 1504 are performed. The time slot 1504 is for the transmission/sending the control message from the controller AGV to the controlled AGV.

In the lower diagram 1500b of FIG. 15, the first feedback 1301, the second feedback 1302 and the third feedback 1303 occur. All three feedbacks 1301, 1302, 1303 are finished after feedback deadline 1505 in the first control cycle. After feedback deadline 1505, a first lost slot 1501 (for feedback processing and control decision) and a second lost slot 1502 (for sending the control command) occur. This first control cycle fails or is lost. After next feedback deadline 1506 in the second control cycle, feedback processing 1503 and sending control message 1504 are performed. The time slot 1504 is for the transmission/sending the control message from the controller AGV to the controlled AGV.

The following scenario illustrates an example of diagram 1500 for aligned fulfillment. This example can be described as follows:

Group QoS treatment policy: “group QoS fulfillment policy, aligned fulfillment, same Alternative QoS Profile AQP level”.

Condition: Two feedbacks 1302, 1303 can fulfil AQP level 1 (within the deadline of 1 control cycle), while feedback 1301 can only fulfill AQP level 2 (within the deadline of 2 control cycles).

Action: RAN relaxes feedback 1302, 1303 also to fulfill AQP level 2 Effect: Saving the resource for feedback 1302, 1303.

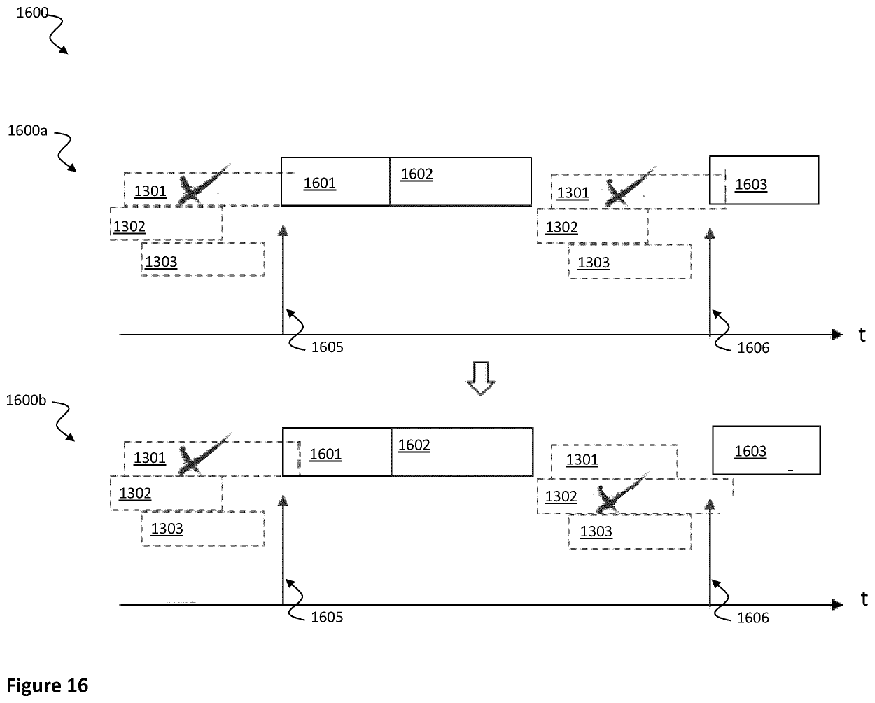

FIG. 16 shows a schematic diagram illustrating an exemplary scenario 1600 of group QoS treatment using fair fulfillment according to the disclosure, on the upper part without group QoS treatment and on the lower part with group QoS treatment.

In the upper diagram 1600a of FIG. 16, a first feedback 1301, a second feedback 1302 and a third feedback 1303 occur. The first feedback 1301 is finished after feedback deadline 1605. After feedback deadline 1605, feedback processing 1601 and sending control message 1602 are performed. The time slot 1602 is for the transmission/sending the control message from the controller AGV to the controlled AGV. Then, a first feedback 1301, a second feedback 1302 and a third feedback 1303 occur. The first feedback 1301 is finished after second feedback deadline 1606. After second feedback deadline 1606, feedback processing 1603 is performed.

In the lower diagram 1600b of FIG. 16, a first feedback 1301, a second feedback 1302 and a third feedback 1303 occur. The first feedback 1301 is finished after feedback deadline 1605 or dropped by the scheduler before the transmission. After feedback deadline 1605, feedback processing 1601 and control message 1602 are performed. Then a first feedback 1301, a second feedback 1302 and a third feedback 1303 occur. In contrast to the upper part diagram 1600a, the second feedback 1302 is finished after second feedback deadline 1606 or dropped by the scheduler before the transmission. After second feedback deadline 1606, feedback processing 1603 is performed.

The following scenario illustrates an example of diagram 1600 for fair fulfillment. This example can be described as follows:
Group QoS treatment policy: “group QoS fulfillment policy, fair fulfillment, and at least two feedbacks need to be guaranteed”
Condition: Radio resource insufficient for all the feedbacks.
Action: feedbacks 1301, 1302, 1303 dropped in a round robin way for fairness
Effect: Ensure more heterogeneous feedback (i.e., from different mobile robots) received at the controller.

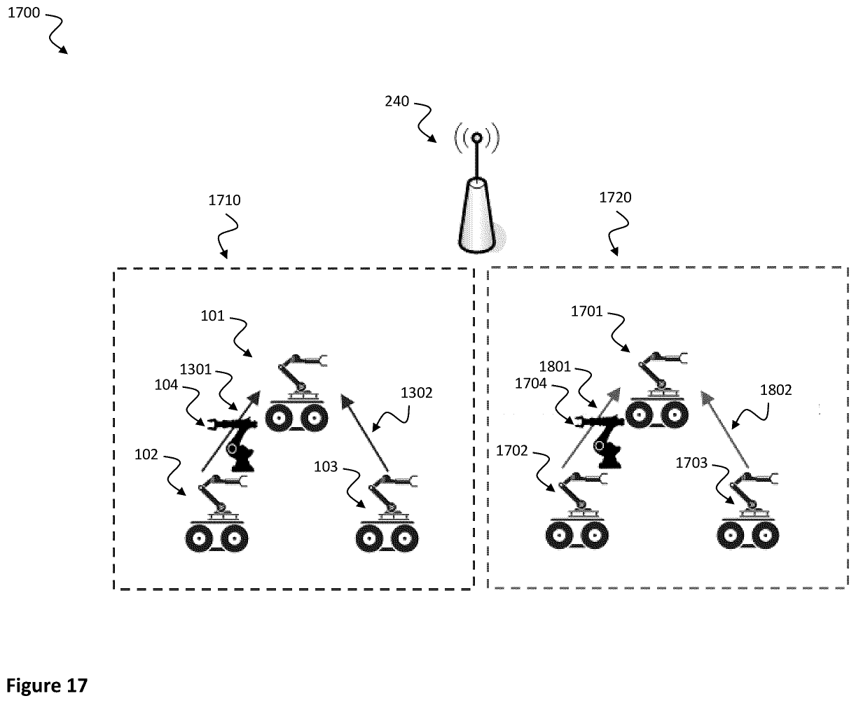

FIG. 17 shows a schematic diagram illustrating an exemplary D2D communication scenario 1700 with two cooperative groups according to the disclosure.

In a first cooperative group 1710, the controller, e.g. vehicle 101 receives control feedback 1301, 1302 from controlled vehicles, e.g. AGVs 102, 103 and robot 104. In a second cooperative group 1720, the controller, e.g. vehicle 1701 receives control feedback 1801, 1802 from controlled vehicles, e.g. AGVs 1702, 1703 and robot 1704. Both cooperative groups 1710, 1720 are connected to RAN 240.

In this example of D2D group communication controlled by RAN 240 (mode 1), for the case in an industrial environment with two communication groups 1710, 1720, each group includes three cooperative mobile robot/AGVs carry large/heavy work pieces. Each QoS flow group has two QoS flows:1301, 1302 (FB #1, FB #2) for first control group 1710 or 1801, 1802 (FB #1, FB #2) for second control group 1720.

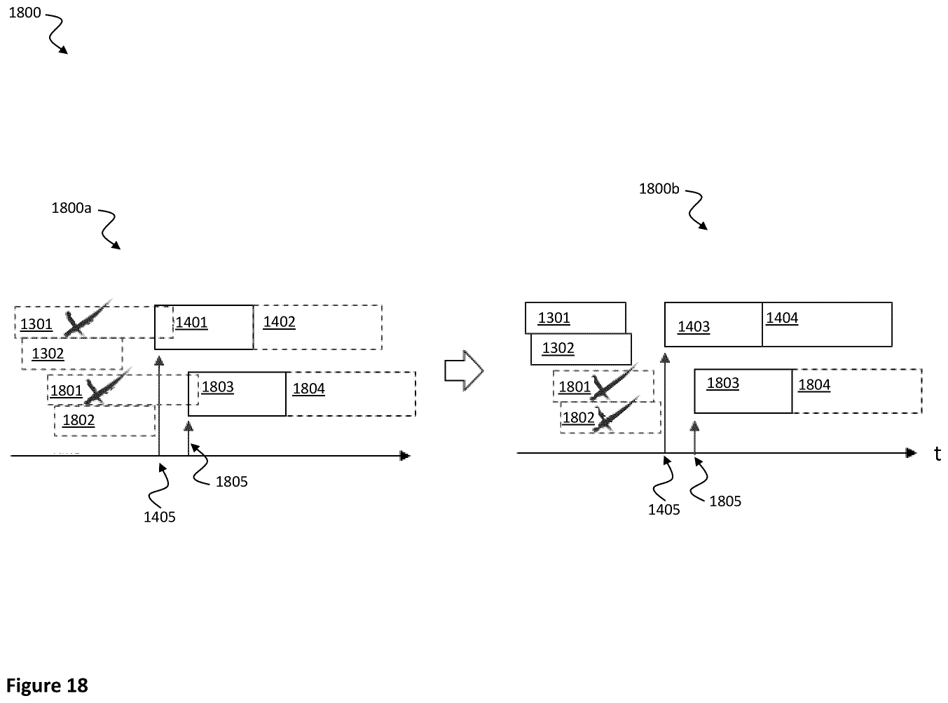

FIG. 18 shows a schematic diagram illustrating an exemplary scenario 1800 of group QoS treatment using joint fulfillment according to the disclosure, on the left without group QoS treatment and on the right with group QoS treatment.

The left-hand diagram 1800a of FIG. 18 shows a timing for a first feedback 1301 of first group 1710, a second feedback 1302 of first group 1710, a first feedback 1801 of second group 1720, a second feedback 1802 of second group 1210, where the first feedback 1301 of first group 1710 is finished after feedback deadline 1405 of first group 1710 and the first feedback 1801 of second group 1720 is finished after feedback deadline 1805 of second group 1720. After feedback deadline 1405 of first group 1710, a first lost slot 1401 (for feedback processing and control decision) and a second lost slot 1402 (for sending the control command) occur. After feedback deadline 1805 of second group 1720, a first lost slot 1803 (for feedback processing and control decision) and a second lost slot 1803 (for sending the control command) Occur.

The right-hand diagram 1800b of FIG. 18 shows the timing for the first feedback 1301 of first group 1710, the second feedback 1302 of first group 1710, the first feedback 1801 of second group 1720 and the second feedback 1802 of second group 1720, where all feedbacks 1301, 1302 are finished before the respective feedback deadline 1405. The first feedback 1801 of second group 1720 and the second feedback 1802 of second group 1720 are dropped. After feedback deadline 1405 of first group 1710, feedback processing 1403 and sending control message 1404 are performed. The time slot 1404 is for the transmission/sending the control message from the controller AGV to the controlled AGV. After feedback deadline 1805 of second group 1720, a first lost slot 1803 (for feedback processing and control decision) and a second lost cycle 1804 (for sending the control command) occur. While QoS of second group 1720 cannot be fulfilled, QoS of first group 1710 can be fulfilled.

The following scenario illustrates an example of diagram 1800 for joint fulfillment used for inter-group resource coordination. This example can be described as follows:
Group QoS treatment policy: “group resource management policy, joint fulfillment, all feedbacks need to be guaranteed”.
Condition: Obstacles delay too much feedback 1301 in first group 1710 and feedback 1801 in second group 1720, Radio resource insufficient for all the feedbacks in both QoS flow groups 1710, 1720
Action: Keep QoS of feedback 1301 in first group 1710 acceptable by drop all the feedbacks in second group 1720.
Effect: QoS of first group 1710 is fulfilled.

FIG. 19 shows a schematic diagram illustrating a mobile communication system 1900 supporting group QoS control according to the disclosure.

The mobile communication system 1900 may include one or more first user devices 1901, 1941, 1942 or UEs, respectively, according to an example, one or more base stations 1910, 1940, one or more QoS control entities 1920 and an application layer 1930.

In the example shown in FIG. 19, the user devices 1901, 1941, 1942 are, by way of example, portable devices, for example, smartphones. However, one or more of these user devices 1901, 1941, 1942 may also be, by way of example, a laptop computer, mobile vehicle or machine-type device. The first user device 1901 may be configured to communicate with the first base station 1910, for instance, via Uu channel 1904. The Uu channel 1904 or also referred to as E-UTRAN Uu interface, also known as LTE Uu or simply LTE radio interface, allows data transfer between the ENodeB (or first base station 1910) and the first UE 1901.

The first base station 1910 may comprise a first network entity, e.g. QoS assurance entity 601 as described above with respect to FIG. 6. The second base station 1940 may comprise a second network entity, e.g. a second QoS assurance entity 602 as described above with respect to FIG. 6.

The second user device 1941 and the third user device 1942 may be configured to communicate with the second base station 1940, for instance, via Uu channel 1944, 1945. The Uu channel 1944, 1945 or also referred to as E-UTRAN Uu interface, also known as LTE Uu or simply LTE radio interface, allows data transfer between the ENodeB (or second base station 1940) and the second and third UEs 1941, 1942.

The user devices 1901, 1941, 1942 may be configured to communicate with each other by sidelink channel without the base stations 1910, 1940. The base stations 1910, 1940 may be configured to communicate with the QoS control entity 1920, e.g. a network entity 1920 via communication links 1911, 1912. The QoS control entity 1920 may be configured to communicate with the application layer 1930 via communication link 1924.

As described above, the first base station 1910 may comprise a first QoS assurance entity 601 and the second base station 1940 may comprise a second QoS assurance entity 602, e.g. as described above with respect to FIGS. 6 to 18.

As can be seen from FIG. 19, the first QoS assurance entity 601 (and analogously the second QoS assurance entity 602) may comprise a processing circuitry 1913 for instance, a processor 1913, for processing and generating data, a transceiver 1915 (also referred to as communication interface 1915), including, for instance, a transmitter, a receiver and an antenna, for exchanging data with the other components of the communication system 1900, and a non-transitory memory 1917 for storing data. The processor 1913 may be implemented in hardware and/or software.

The hardware may comprise digital circuitry, or both analog and digital circuitry. Digital circuitry may comprise components such as application-specific integrated circuits (ASICs), field-programmable arrays (FPGAs), digital signal processors (DSPs), or general-purpose processors. The non-transitory memory 1917 may store data as well as executable program code which, when executed by the processor 1913, causes the respective first base station 1910 to perform the functions, operations and methods described in this disclosure.

In an example, the QoS control entity 1920, e.g. network entity 1920, may have a similar architecture as the first QoS assurance entity 601, i.e. may comprise a processor 1923 for processing and generating data, a transceiver 1925 (also referred to as communication interface 1925) for exchanging data with the other components of the communication system 1900 as well as a memory 1927 for storing data.

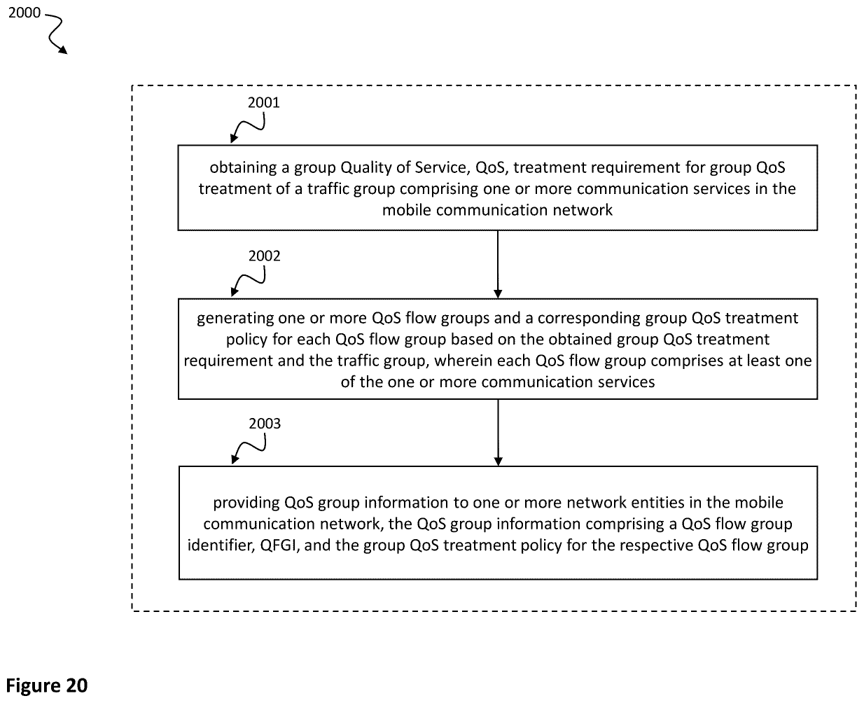

FIG. 20 shows a schematic diagram illustrating a method 2000 for controlling communication service of a mobile communication network according to the disclosure.

The method 2000 comprises a step 2001 of obtaining group Quality of Service, QoS, treatment requirement(s) 621 for group QoS treatment of a traffic group comprising one or more communication services of one or more UEs in the mobile communication network 600, e.g. as described above with respect to FIGS. 6 to 19.

The method 2000 further comprises a step 2002 of generating one or more QoS flow groups and a corresponding group QoS treatment policy for each QoS flow group based on the obtained group QoS treatment requirement(s) 621 and the traffic group, wherein each QoS flow group comprises at least one of the one or more communication services, e.g. as described above with respect to FIGS. 6 to 19.

The method 2000 further comprises a step 2003 of providing QoS group information 611, 612, 613 to one or more network entities 601, 602, 603, for example, QoS assurance network entities 601, 602, 603 in the mobile communication network (600), the QoS group information 611, 612, 613 comprising a QoS flow group identifier, QFGI, and the group QoS treatment policy for the respective QoS flow group, e.g. as described above with respect to FIGS. 6 to 19.

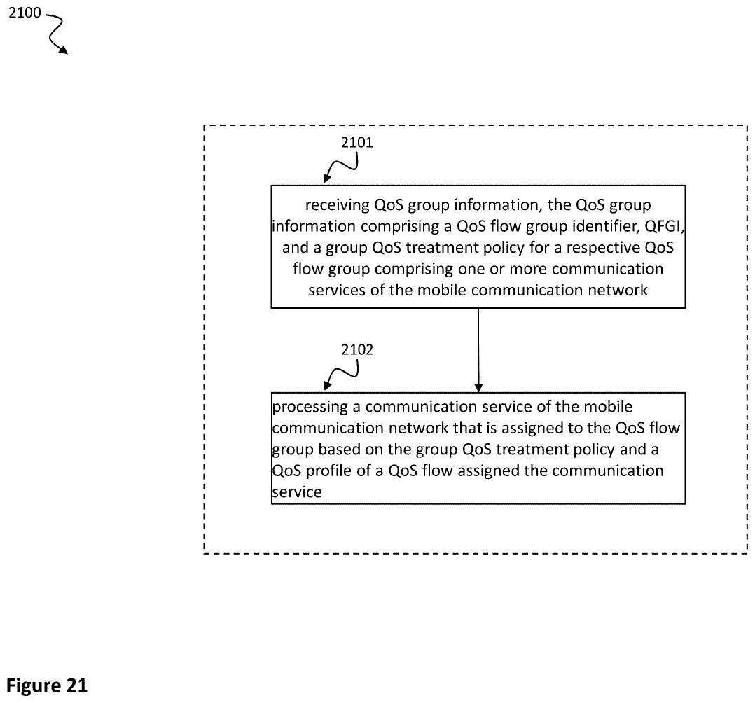

FIG. 21 shows a schematic diagram illustrating a method 2100 for assuring Quality of Service according to the disclosure.

The method 2100 comprises a step 2101 of receiving QoS group information 611, 612, 613, the QoS group information 611, 612, 613 comprising a QoS flow group identifier, QFGI, and a group QoS treatment policy for a respective QoS flow group comprising one or more communication services of the mobile communication network 600, e.g. as described above with respect to FIGS. 6 to 19.

The method 2100 further comprises a step 2102 of processing a communication service of the mobile communication network 600 that is assigned to the QoS flow group based on the group QoS treatment policy and QoS profile of the communication service, e.g. as described above with respect to FIGS. 6 to 19.

The present disclosure also supports a computer program product including computer executable code or computer executable instructions that, when executed, causes at least one computer to execute the performing and computing steps described herein for the methods and procedures described in accordance with one or more embodiments. Such a computer program product may include a readable non-transitory storage medium storing program code thereon for use by a computer. The program code may perform the processing and computing steps described herein for the methods and procedures described in accordance with one or more embodiments.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of this disclosure beyond those described herein. While the present disclosure has been described with reference to one or more particular embodiments, those skilled in the art recognize that many changes may be made thereto without departing from the scope of the present disclosure. It is therefore to be understood that variations within the scope of the appended claims and their equivalents may be practiced otherwise than as described herein.

1. A control entity for controlling a communication service of a mobile communication network, the control entity comprising:
a first communication interface configured to obtain a group, quality of service (QoS) treatment requirement for group QoS treatment of a traffic group comprising one or more communication services in the mobile communication network; network;
a processor configured to generate one or more QoS flow groups and a corresponding group QoS treatment policy for each QoS flow group based on the obtained group QoS treatment requirement and the traffic group, wherein each QoS flow group comprises at least one of the one or more communication services; and
a second communication interface configured to provide QoS group information to one or more network entities in the mobile communication network, the QoS group information comprising a QoS flow group identifier and the group QoS treatment policy for a corresponding QoS flow group.

2. The control entity of claim 1, wherein the processor is further configured to assign a corresponding QoS flow group identifier to the one or more QoS flow groups.

3. The control entity of claim 2, wherein the group QoS treatment requirement is obtained directly from an application layer or from the application layer via by way of a network entity, wherein the network entity comprises one or more of an application function, a network exposure function, or a unified data repository.

4. The control entity of claim 3, wherein the group QoS treatment requirement is obtained together with a traffic group identifier of the traffic group directly from the application layer or from the application layer by way of the network entity, wherein the traffic group identifier is configured to identify the traffic group.

5. The control entity of claim 3, wherein a traffic group identifier of the traffic group is obtained directly from the application layer or from the application layer by way of the network entity, the group QoS treatment requirement is obtained from a database, and the traffic group identifier is configured to identify the traffic group.

6. The control entity of claim 1, wherein one or more of the group QoS treatment policy or the group QoS treatment requirement comprises at least one of:
a percentage of communication services of the one or more communication services in at least one of the QoS flow group or the traffic group of which the QoS needs to be fulfilled,
a percentage of communication services of the one or more communication services in at least one of the QoS flow group or the traffic group of which the QoS does not need to be fulfilled,
a percentage of communication services in at least one of the QoS flow group or the traffic group to be treated as a whole for group resource management,
a parameter controlling a fair chance of at least one of QoS fulfillment or group resource management for each communication service within one or more of the QoS flow group or the traffic group,
an indication of an allowed communication latency threshold with respect to a number of control cycles, or
a parameter for aligning an arrival time.

7. The control entity of claim 6, wherein a policy for the group resource management comprises at least one of:
a combined admission control during QoS Flow establishment or handover, or
a combined smart resource scheduling at a radio access network.

8. The control entity of claim 1, wherein
one or more of the group QoS treatment policy or the group QoS treatment requirement further comprises information dedicated for the group QoS treatment, and
the information dedicated for the group QoS treatment comprises at least one of:
a validating condition of the group QoS treatment comprising a minimum group size, a temporal validity condition, or a spatial validity condition, or
a group QoS treatment pattern comprising an execution of group QoS treatment periodically or in a flow life time.

9. The control entity of claim 1, wherein the second communication interface is configured to provide the QoS group information together with a QoS profile per QoS flow to the one or more network entities based on at least one of a session management procedure or a policy association procedure.

10. The control entity of claim 1, wherein the second communication interface is configured to provide the QoS group information together with a QoS profile per QoS flow to the one or more network entities based on a session management procedure by way of an access mobility management function entity.

11. The control entity of claim 1, wherein the control entity is implemented in at least one of:
a network function entity of the mobile communication network of the mobile communication network, a policy control function entity, or a network exposure function entity of the mobile communication; network; or
a user device.

12. The control entity of claim 11, wherein the control entity is implemented in the user device, and the second communication interface is configured to provide the QoS group information together with a QoS profile per QoS flow to a radio access network entity of the mobile communication network by way of radio resource control signaling.

13. A network entity for assuring a of service (QoS) of a traffic group comprising one or more communication services of one or more user equipments (UEs) in a mobile communication network, the network entity comprising:
a communication interface configured to receive QoS group information, the QoS group information comprising a QoS flow group identifier and a group QoS treatment policy for a corresponding QoS flow group comprising one or more communication services of the mobile communication network; and
a processor configured to process a communication service of the mobile communication network that is assigned to the QoS flow group based on the group QoS treatment policy and a QoS profile of a QoS flow assigned to the communication service.

14. The network entity of claim 13, wherein the QoS flow group identifier is assigned to the corresponding QoS flow group.

15. The network entity of claim 13, wherein the group QoS treatment policy for the corresponding QoS flow group comprises at least one of:
a percentage of communication services of the one or more communication services in at least one of the corresponding QoS flow group or the traffic group of which the QoS needs to be fulfilled,
a percentage of communication services of the one or more communication services at least one of the corresponding QoS flow group or the traffic group of which the QoS does not need to be fulfilled,
a percentage of communication services at least one of the corresponding QoS flow group or the traffic group to be treated as a whole for group resource management,
a parameter controlling a chance of at least one of QoS fulfillment or group resource management for each communication service within one or more of the corresponding QoS flow group or the traffic group,
an indication of an allowed communication latency threshold with respect to a number of control cycles, or
a parameter for aligning an arrival time.

16. The network entity of claim 15, wherein a policy for the group resource management comprises at least one of:
a combined admission control during QoS Flow establishment or handover, or
a combined smart resource scheduling at a radio access network.

17. The network entity of claim 13, wherein
one or more of the group QoS treatment policy for the corresponding QoS flow group further comprises information dedicated for the group QoS treatment, and
the information dedicated for the group QoS treatment comprises at least one of:
a validating condition of the group QoS treatment comprising a minimum group size, a temporal validity condition, or a spatial validity condition, or
a group QoS treatment pattern comprising an execution of group QoS treatment periodically or in a flow life time.

18. The network entity of claim 13, wherein the processor is further configured to one or more of:
assign resources,
perform smart scheduling,
perform an admission control, or
perform QoS assurance of the mobile communication network to the communication service based on the group QoS treatment policy and the QoS profile of a QoS flow assigned to the communication service.

19. The network entity of claim 13, further comprising one or more of a radio access network entity or a core network entity of the mobile communication network.

20. A method for controlling a communication service of a mobile communication network, the method comprising:
obtaining a group quality of service (QoS) treatment requirement for group QoS treatment of a traffic group comprising one or more communication services in the mobile communication network;
generating one or more QoS flow groups and a corresponding group QoS treatment policy for each QoS flow group based on the obtained group QoS treatment requirement and the traffic group, wherein each QoS flow group comprises at least one of the one or more communication services; and
providing QoS group information to one or more network entities in the mobile communication network, the QoS group information comprising a QoS flow group identifier and the group QoS treatment policy for the corresponding QoS flow group.
